(19) United States
(12) Patent Application Publication
(10) Pub. No.: US 2026/0288908 A1
(43) Pub. Date: Sep. 24, 2026

(54) SYSTEM

(71) Applicant: SoftBank Group Corp., Tokyo (JP)

(72) Inventor: Erika OBA, Tokyo (JP)

(73) Assignee: SoftBank Group Corp., Tokyo (JP)

(21) Appl. No.: 19/567,020

(22) Filed: Mar. 14, 2026

(30) Foreign Application Priority Data
Mar. 19, 2025 (JP) 2025-045219

(51) Int. Cl. G06F 18/2415; G06F 21/62

(52) U.S. Cl. CPC G06F 18/2415; G06F 21/6218

(57) ABSTRACT

A system includes a processor that is configured to provide an interface through which a user inputs dream content, analyze the input dream content using a deep learning algorithm and extract features from the dream content, and estimate a current thought or emotion of the user based on an analysis result of the dream content and generate and provide concrete advice for improving mental health of the user based on the analysis result.

### CROSS-REFERENCE TO RELATED APPLICATION

This application is based on and claims priority under 35 USC 119 from Japanese Patent Application No. 2025-045219 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional mental health support systems in workplaces and other environments generally rely on direct questionnaires, interviews, or self-reported stress checks. Such approaches often suffer from low utilization and low accuracy because users may be reluctant to disclose their true feelings or may lack the awareness to accurately report their own mental state. Further, existing systems typically do not utilize dream content as a source of information, even though dreams can implicitly reflect a user's thoughts and emotions. Moreover, in systems that collect personal psychological data, there is a significant risk to user privacy if data is not properly anonymized and access-controlled. Therefore, there is a need for a system that can automatically analyze dream content using deep learning techniques, estimate a user's current thoughts and emotions, and provide concrete advice for improving mental health, while also tracking changes over time and protecting user privacy through anonymization and restricted data access.

### SUMMARY

In order to solve the above-described problems, the present invention provides a system comprising a processor, wherein the processor is configured to provide an interface through which a user inputs dream content, analyze the input dream content using a deep learning algorithm and extract features from the dream content, and estimate a current thought or emotion of the user based on an analysis result of the dream content and generate and provide concrete advice for improving mental health of the user based on the analysis result. The processor is further configured to store dream content and corresponding analysis results for a predetermined period in a database, track a change in the mental health of the user using accumulated data stored in the database, and optimize the advice based on the change in the mental health of the user. In addition, the processor is configured to anonymize personal information and restrict data access in order to protect privacy of the user.

The term “system” refers to a combination of hardware and software components, including at least one processor and associated memory, storage, and communication interfaces, configured to perform the functions described in the claims.

The term “processor” refers to one or more processing units, such as a central processing unit (CPU), graphics processing unit (GPU), digital signal processor (DSP), or other programmable logic or computing element, which executes instructions to perform the claimed functions.

The term “interface” refers to a hardware and/or software mechanism, such as a graphical user interface, web page, mobile application screen, or application programming interface (API), that enables a user or an external system to input or receive information.

The term “user” refers to an individual, such as an employee or other person, who inputs dream content into the system and receives analysis results and advice from the system.

The term “dream content” refers to a textual description or other representable expression of a dream experienced by the user, including statements entered by the user that describe events, scenes, emotions, or narratives perceived during sleep.

The term “deep learning algorithm” refers to a machine learning technique employing a neural network having multiple layers, such as a convolutional neural network, recurrent neural network, transformer, or other multi-layer architecture, which processes input data to learn representations and perform tasks including analysis and prediction.

The term “analyze the input dream content using a deep learning algorithm” refers to processing the dream content with a deep learning model so as to extract features, patterns, or representations indicative of emotional or cognitive states.

The term “extract features” refers to generating numerical or symbolic representations from the dream content, such as embeddings, vectors, or categorical indicators, that characterize semantic, emotional, or structural aspects of the dream content for use in subsequent estimation or advice generation.

The term “analysis result” refers to data derived from the processing of dream content by the deep learning algorithm, including but not limited to detected patterns, feature values, classification outcomes, or scores that are used to estimate the user's thoughts and emotions.

The term “current thought or emotion of the user” refers to a mental or emotional state of the user at or near the time of dream submission, such as stress level, anxiety level, or other psychological conditions, as inferred from the analysis result.

The term “concrete advice for improving mental health” refers to specific, actionable recommendations or guidance, such as behavioral suggestions, self-care techniques, or indications to seek professional support, that are generated by the system to help the user manage or improve mental well-being.

The term “provide concrete advice” refers to outputting the generated advice to the user via the interface, including displaying, transmitting, or otherwise making the advice accessible to the user.

The term “database” refers to an organized collection of data stored in one or more storage devices, managed by a database management system or equivalent data storage mechanism, that allows storing, retrieving, and updating dream content, analysis results, and related information.

The term “store dream content and corresponding analysis results for a predetermined period” refers to recording the dream content and its analysis result in the database and retaining such records for at least a specified duration or specified number of entries before deletion, archiving, or anonymization.

The term “accumulated data” refers to a set of multiple records of dream content and their associated analysis results stored in the database over time for the same user or for multiple users.

The term “track a change in the mental health of the user” refers to determining temporal variations or trends in the inferred mental or emotional states of the user by analyzing successive analysis results stored in the database.

The term “optimize the advice” refers to adjusting the content, timing, or priority of the advice based on historical patterns or detected changes in the user's mental health, so as to provide advice that is better tailored to the user's current and long-term condition.

The term “personal information” refers to information that can identify or is associated with a specific user, such as a name, employee ID, contact information, or other identifying attributes.

The term “anonymize personal information” refers to processing personal information so that an individual user cannot be directly or reasonably re-identified, for example by replacing identifiers with pseudonyms, removing identifying fields, or applying irreversible transformations.

The term “restrict data access” refers to limiting access to stored data through authentication, authorization, role-based control, encryption, or other security mechanisms, such that only permitted entities can access specific data and that unauthorized access is prevented.

The term “privacy of the user” refers to the protection of the user's identity and personal psychological information from unauthorized disclosure, re-identification, or use beyond the intended purposes of the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

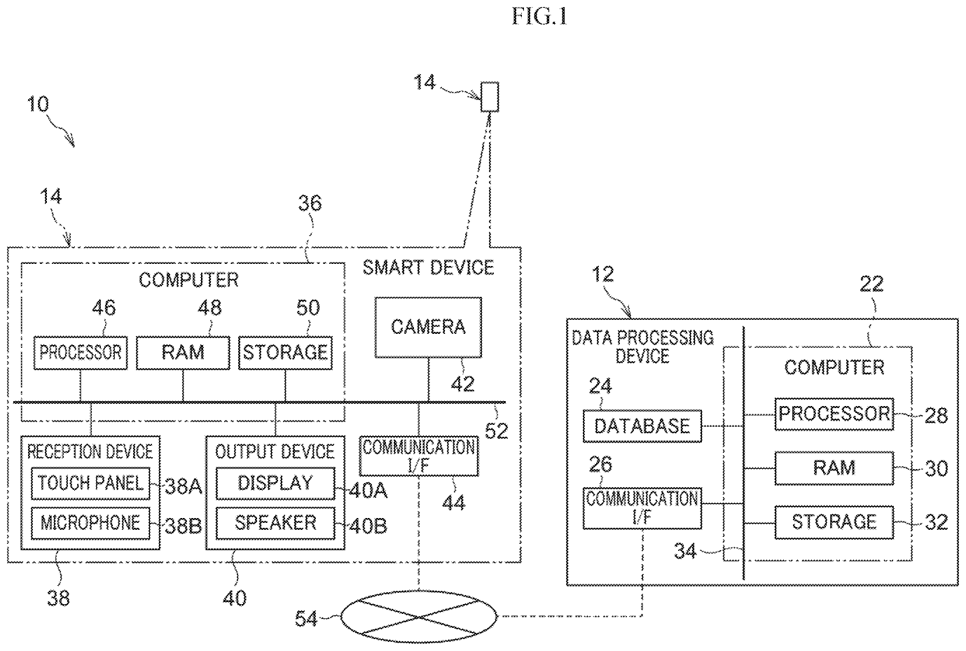

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

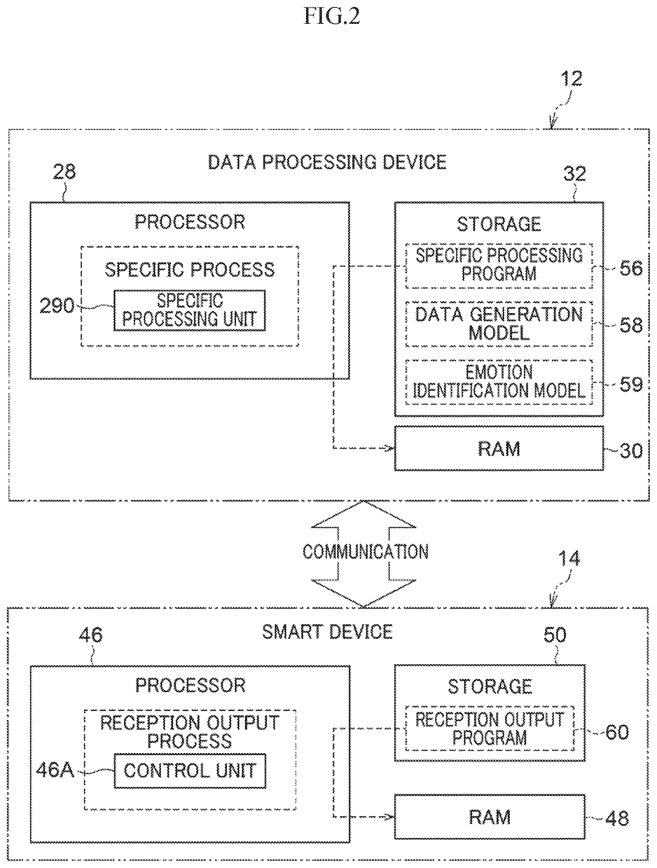

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional mental health support systems that rely on user questionnaires or static rule-based assessments suffer from several technical limitations in the way they process, analyze, and utilize unstructured textual data on computer systems. First, known systems generally treat user input as a simple text field and apply shallow pattern matching or fixed keyword rules, which results in limited exploitation of the capabilities of advanced natural language processing models. This leads to inefficient use of processor and memory resources, because the systems do not structure the input into optimized prompts for modern generative models, and therefore cannot fully leverage the representational power of such models to infer nuanced psychological states.

Second, existing architectures typically separate text collection, model execution, and long-term analysis into loosely coupled modules without a unified data flow optimized for iterative AI inference. As a result, long-term trend analysis over accumulated user data is either not performed or is performed using offline, manual data mining workflows. This creates technical inefficiencies, including redundant data transformations, multiple incompatible data formats, and high latency between data acquisition and generation of updated guidance. The lack of an integrated pipeline for generating prompt sentences, executing a generative model, and storing normalized state information inhibits real-time or near real-time adaptation of advice on the basis of historical patterns.

Third, some existing systems do not adequately address privacy-preserving computation at the architectural level. User identifiers are often stored or processed together with raw text and analysis results in a way that complicates access control and increases the risk of unintended disclosure. Technical mechanisms such as irreversible transformation of identifiers, attribute generalization, and explicit binding of access control policies to stored records are not consistently integrated with the core data processing pipeline. As a consequence, the systems face trade-offs between model accuracy and strict privacy constraints, and may require manual or ad hoc anonymization steps that are error-prone and computationally inefficient.

Fourth, the processing of dream-related text, which tends to be highly subjective and metaphorical, poses a specific technical challenge for conventional text analysis engines. Typical classification models or rule-based engines are not well adapted to interpret symbolic or narrative content. Without a systematic mechanism to construct context-rich prompt sentences, feed them to a generative AI model, and then normalize the output into structured state information, the computing system cannot robustly transform free-form dream descriptions into machine-interpretable psychological indicators. This leads to underutilization of storage and processing resources, because dream content is stored as raw text without being converted into normalized features suitable for temporal analysis and automated advice generation.

Accordingly, there is a need for an improved computer-implemented system and method that: (i) systematically converts user-provided dream descriptions into prompt sentences optimized for a generative AI model; (ii) executes the generative model to derive structured psychological state information and explanatory information; (iii) integrates long-term trend analysis driven by the same or related generative models; and (iv) performs built-in anonymization and controlled access to the stored data. Such a system should improve the efficiency, reliability, and scalability of the underlying computing infrastructure by providing a unified pipeline from secure acquisition of unstructured text, through AI-based analysis, to storage and trend-aware advice generation, while enforcing privacy at the data model and access-control levels.

The specific processing by the specific processing unit 290 of the data processing device 12 in Example 1 is realized by the following means.

The present invention provides a server comprising a processor configured to present, on an information terminal, an interactive screen that allows a user to input description information representing dream content experienced during sleep; to receive, from the information terminal via a secure communication scheme, the description information; to generate a prompt sentence including the description information and to generate analysis input data including the prompt sentence; to execute, on an information processing apparatus, a generative model having natural language processing functionality and deep learning functionality so as to subdivide the analysis input data into symbol sequences, convert the symbol sequences into numerical representations, extract feature quantities, and generate state information indicating a psychological state of the user and explanation information indicating a basis for the state information; to generate advice information intended to improve mental health of the user based on the state information; to transmit the advice information and the state information to the information terminal as response information; to record the description information, the state information, and the advice information in a storage device as a data collection in a form separated from identification information; to acquire, from the data collection, a plurality of pieces of state information corresponding to an anonymous user; to calculate trend information regarding temporal changes based on the plurality of pieces of state information; to generate summary information including the trend information by using a prompt sentence for the generative model; to update the advice information based on the summary information; and to convert user identification information into anonymous information by performing irreversible transformation processing and attribute generalization processing and to restrict an access range to the recorded information based on authentication information and access control information. This enables improved computer-implemented processing of unstructured dream descriptions into structured psychological state information and adaptive advice, efficient execution of a generative model through optimized prompt construction, integrated long-term trend analysis over anonymized data, and privacy-preserving storage and access control within a unified server-side architecture.

The term “information terminal” refers to an electronic device operated by a user and configured to present an interactive screen and to send and receive data over a communication network, such as a smartphone, a tablet, a personal computer, or a similar computing device.

The term “interactive screen” refers to a user interface presented on an information terminal that enables a user to input, edit, and confirm information, and to view responses provided by a server, using input operations such as typing, touching, clicking, or similar interactions.

The term “description information” refers to character data or text data input by a user and representing content of a dream or mental experience during sleep, including narrative expressions, emotions, events, or any other user-provided textual content.

The term “secure communication scheme” refers to a communication protocol or mechanism that encrypts data transmitted between an information terminal and a server so as to prevent unauthorized interception or tampering, such as a transport-layer security protocol.

The term “prompt sentence” refers to a text string generated by a processor and including at least a portion of description information, the text string being configured to serve as an instruction or query to a generative model for analysis or generation of subsequent text.

The term “analysis input data” refers to electronic data provided to a generative model, the data including at least one prompt sentence and optionally additional metadata, and being formatted for processing by natural language processing and deep learning functions.

The term “generative model” refers to a trained information processing model that implements natural language processing and deep learning to generate output data, such as text or scores, in response to input data, including but not limited to models based on neural network architectures.

The term “symbol sequences” refers to ordered lists of discrete units, such as tokens, characters, subword units, or words, obtained by transforming text data into elements that can be processed by a generative model.

The term “numerical representations” refers to vector data, tensor data, or other numerical encodings generated from symbol sequences, suitable for processing by computational operations in a generative model.

The term “feature quantities” refers to numerical values or data structures derived from numerical representations and capturing semantic, emotional, or contextual characteristics of description information for use in further analysis by a processor.

The term “state information” refers to data indicating an inferred psychological condition, emotion, mood, or mental tendency of a user, derived from processing of description information by a generative model.

The term “explanation information” refers to data indicating a rationale, basis, or interpretation associated with state information, including textual explanations or structured indicators that describe how a psychological state was inferred.

The term “advice information” refers to generated content intended to support or improve mental health of a user, including guidance, suggestions, or recommended actions derived at least in part from state information or trend information.

The term “response information” refers to data transmitted from a server to an information terminal and including at least state information and advice information for presentation on an interactive screen.

The term “storage device” refers to a hardware or virtual component configured to store electronic data, such as a magnetic disk, a solid-state drive, a memory device, or a network-based storage system.

The term “data collection” refers to an organized aggregation of multiple records stored in a storage device, the records including description information, state information, advice information, or related metadata.

The term “identification information” refers to data that directly or indirectly identifies a specific user, such as a user identifier, an account identifier, contact information, or any combination of attributes that can be used for personal identification.

The term “anonymous user” refers to a user represented in stored data only by anonymous information, without direct identification information that allows the user to be personally identified.

The term “trend information” refers to data indicating temporal changes or patterns over a period, derived from multiple pieces of state information associated with a user, such as variations in psychological scores or emotional categories over time.

The term “summary information” refers to data that consolidates or abstracts trend information into a more concise representation, including text generated by a generative model that describes temporal patterns in a user's psychological state.

The term “irreversible transformation processing” refers to a computational procedure that converts identification information into a transformed representation, such that the original identification information cannot be feasibly reconstructed from the transformed representation.

The term “attribute generalization processing” refers to a modification of attributes associated with a user, such as replacing specific values with broader categories or ranges, to reduce identifiability while preserving analytical utility.

The term “anonymous information” refers to information obtained after applying irreversible transformation processing and attribute generalization processing to identification information, such that an individual user cannot be identified from the information.

The term “authentication information” refers to data used to verify the identity of an accessing entity, such as login credentials, tokens, certificates, or similar access verification data.

The term “access control information” refers to data defining permitted operations, roles, or scopes of access for an entity with respect to stored data, such as access rights, permission levels, or policy rules.

In one embodiment, a server, a plurality of terminals, and one or more storage devices are interconnected via a communication network. The server includes at least one processor and at least one memory storing instructions, a trained generative AI model, and associated data structures. The terminals include computing devices such as smartphones, tablet computers, or personal computers equipped with a graphical user interface, network communication modules, and local memory.

The terminal provides a concrete hardware and software environment for user interaction. The terminal executes an application program, such as a native mobile application or a web browser, that displays an interactive screen. The terminal uses a display unit, an input unit (such as a touch panel or keyboard), and an operating system network stack to communicate with the server. The terminal renders input fields, buttons, and text areas using an application framework (for example, a browser engine or a mobile UI toolkit) and sends user input as structured data to the server over a secure transport protocol.

The user operates the terminal to input description information representing dream content experienced during sleep. The user views the interactive screen and types a free-form text such as “Last night I dreamed that I was flying in the sky.” or “Last night in my dream, I was being chased by a huge wave.” The user can optionally add contextual information, for example, “I feel this dream is related to pressure from upcoming deadlines.” The terminal temporarily stores this text in a local buffer managed by the application and then transmits the text to the server.

The terminal uses a secure communication scheme, such as a transport-layer security protocol over a network stack, to send the description information to the server. The terminal encapsulates the description information in a message body, attaches authentication headers, and transmits the message to a server endpoint. The terminal receives a response from the server and displays state information and advice information on the same interactive screen, allowing the user to review inferred psychological states and recommended actions.

The server receives the description information from the terminal and performs a series of concrete computational operations to transform the unstructured text into structured state information and advice information. The server runs an application layer program, for example implemented with a server-side framework, that parses incoming messages, validates data formats, and hands description information to an analysis module. The server uses the processor and memory to construct a prompt sentence tailored for a generative AI model.

The server generates a prompt sentence by inserting at least a part of the description information into a template. For example, the server constructs the following prompt sentence:
“Analyze the following dream content and infer the user's current emotions and thoughts. Output (1) the inferred psychological state and (2) a short explanation. Dream: ‘Last night I dreamed that I was flying in the sky.’”

In another example, the server constructs the following prompt sentence:
“Last night in my dream, I was being chased by a huge wave. Please infer my emotions and thoughts from this dream and explain what psychological state this might reflect.”

The server formats this prompt sentence as analysis input data. The server may attach metadata such as language code, time zone, or anonymized user identifier, but the main portion of the analysis input data is the prompt sentence. The server stores the prompt sentence in memory as a character string and converts it into a sequence of tokens using a tokenizer associated with the generative AI model.

The server uses a generative AI model implemented with a deep learning framework such as a generic tensor computation library. The generative AI model includes a neural network architecture, for example a Transformer-based sequence model having an embedding layer, multiple self-attention layers, feed-forward layers, and an output layer. The server loads learned parameters (weights and biases) into memory and deploys the model on processing hardware such as a central processing unit and optionally a graphics processing unit. The server may use a library supporting tensor operations and automatic differentiation to execute forward passes of the model efficiently.

The server converts the prompt sentence into symbol sequences by applying a subword tokenizer, such as a byte-pair encoding tokenizer. The server maps each symbol to a token identifier and stores the sequence of token identifiers in an integer array. The server then converts the integer array into numerical representations by mapping each token identifier to an embedding vector, resulting in a sequence of high-dimensional vectors. The server builds tensor objects that represent sequences, attention masks, and optional segment identifiers.

The server processes these tensors through the generative AI model. The server computes multi-head self-attention, linear transformations, and non-linear activations layer by layer. The server calculates, for each token position, context-dependent vector representations capturing semantic and emotional cues from the entire prompt sentence. The server then applies output projection layers to generate either logits for classification tasks or probability distributions over vocabulary items for text generation.

The server is configured so that the generative AI model outputs both structured and unstructured data. In one implementation, the server appends explicit instruction tokens to the prompt sentence, instructing the model to output JSON-like key phrases, which are then parsed into state information. In another implementation, the server uses a multi-head output layer trained to produce numerical emotion scores (such as anxiety, calmness, sadness) and a separate text decoder to output an explanation. The server thus obtains state information indicating a psychological state of the user and explanation information indicating a basis for the inferred state.

The server converts output token sequences from the generative AI model back into text strings using the tokenizer's decoding function. The server parses the generated text to extract structured information, for example by searching for predefined labels or delimiters. The server maps phrases such as “feeling overwhelmed by responsibilities” or “experiencing a desire for freedom and escape” to internal codes stored in a data structure. The server normalizes each value into a predefined numerical range, thereby enabling efficient comparison and aggregation over time.

The server generates advice information based on the state information. In one embodiment, the server uses a rule-based engine that applies decision rules to the normalized state information. For example, if an anxiety score exceeds a specified threshold, and if themes of “chasing” or “threat” are detected, the server selects a rule that emphasizes relaxation strategies. The server then constructs a textual message such as “Try incorporating a short breathing exercise before going to bed and write down your main worries to help your mind relax.”

In another embodiment, the server uses the generative AI model itself to generate advice information. The server constructs a prompt sentence such as:
“The user's dream analysis suggests increased anxiety related to work pressure. Generate a short, practical, non-clinical advice message to help the user manage this anxiety.”

The server feeds this prompt to the same or a related generative AI model. By using the generative model in this controlled, prompt-based manner, the server leverages model capabilities to create personalized advice while maintaining constraints such as maximum length and avoidance of clinical diagnoses. The server can post-process the generated advice text to remove prohibited terms, enforce tone guidelines, and ensure compliance with system policies.

The server records, in a storage device, the description information, the state information, and the advice information. The server manages these data elements as records in a data collection. The server uses a relational schema or a document-oriented schema to store each record with fields such as anonymized user identifier, timestamp (optionally generalized to date), raw dream text, normalized psychological scores, explanation text, and advice text. The server applies indexing on anonymized identifiers and time attributes to support efficient queries for long-term trend analysis.

The server performs anonymization to protect user privacy. Before recording data, the server separates identification information from description information and state information. The server converts identification information into anonymous information by applying irreversible transformation processing, such as a cryptographic hash function, and attribute generalization processing, such as mapping precise age to an age range or exact location to a broader region. The server stores anonymous information in association with the description information and state information. The server enforces access control policies by using authentication information and access control information, so that only authorized entities can access specific subsets of the stored records.

The server acquires multiple pieces of state information corresponding to the same anonymous user and calculates trend information regarding temporal changes. The server retrieves records from the storage device using a query that filters on the anonymized identifier and sorts results by time. The server loads psychological scores into numeric arrays and applies algorithms such as moving averages, exponential smoothing, or clustering to detect patterns. The server computes changes in mean anxiety level, frequency of specific dream themes, or variability of emotional states over pre-defined periods.

The server may use the generative AI model again to generate summary information based on trend information. For example, the server constructs a prompt sentence such as:
“Given the following time-series of emotional scores and themes, generate a concise summary of how the user's mental state has changed over the past three months. Avoid clinical language and keep it under 150 words.”

The server then includes a structured representation of the trend information in the prompt. The generative AI model receives this prompt and outputs a natural-language summary, which the server decodes and stores as summary information. The server subsequently updates advice information according to the summary information, for example by recommending adjustments in daily routines or encouraging consistent use of relaxation techniques.

The server thus implements a non-conventional data processing pipeline that improves computer technology. By constructing prompt sentences that explicitly embed dream content and analysis instructions, the server reduces ambiguity in model inputs and enables more accurate and efficient inference. The server converts free-form descriptions into symbol sequences and numerical representations optimized for a particular neural architecture, thereby improving utilization of computational resources. Because the server stores normalized state information and explanation information in structured form, subsequent trend analysis can be performed with reduced computation compared to re-parsing raw text each time.

The server also improves technical performance by separating identification information from content data and by applying anonymization at the time of recording. This architectural separation allows the server to maintain fine-grained access control policies implemented at the storage and application layers, reducing the likelihood of unauthorized disclosure while still enabling high-volume analysis of anonymized records. The use of indices and normalized features allows the server to retrieve and analyze historical data with lower latency and lower memory consumption compared to systems that would repeatedly process large amounts of raw text.

In one implementation, the server trains the generative AI model using a supervised or semi-supervised learning procedure. The server prepares training data sets consisting of pairs of dream-related prompts and target outputs. Target outputs may include labeled emotional categories, numerical scores, and explanatory text. The server uses a loss function combining cross-entropy loss for classification components and sequence-to-sequence loss for text generation components. The server updates neural network weights using a gradient-based optimization algorithm such as stochastic gradient descent with momentum or an adaptive optimization method. During training, the server performs data augmentation techniques, for example paraphrasing dream descriptions or adding noise to text, to improve model robustness.

The server stores the trained model parameters in the storage device and loads them into memory at runtime. The server may use quantization or model pruning to reduce model size and improve inference speed. The server can also distribute computation across multiple processing units, scheduling forward passes so as to balance throughput and latency constraints.

The server uses the generative AI model to perform operations that are not a simple automation of human mental tasks. For example, the server analyzes high-dimensional embedding vectors and attention patterns across entire sequences of tokens, applying mathematical operations that are impractical for a human to perform. The server can process large volumes of dream descriptions and compute temporal trends across thousands of records in real time or near real time, which extends beyond the capacity of human evaluators. By combining prompt-based generative modeling with structured normalization and anonymized storage, the server improves the technical functioning of the system by enabling faster and more accurate pattern detection, reducing redundant computations, and optimizing memory layout.

In a variant embodiment, the server uses an ensemble of generative models, each trained on different subsets or different objective functions, and aggregates their outputs to obtain more stable state information. The server may weight the outputs of the models based on validation performance or uncertainty estimation. In another embodiment, the server deploys a lighter-weight model for real-time inference on edge devices and a larger model for periodic batch processing on the server side. The terminal can then perform preliminary analysis locally to reduce network traffic, sending only compressed intermediate features to the server.

In another variation, the server adapts the prompt sentence based on historical behavior of the model. The server monitors which prompt formulations lead to higher agreement with subsequent user feedback and adjusts templates dynamically. This structure improves inference quality without changing the underlying model parameters, representing an optimization at the prompt-engineering level.

The terminal can implement further technical improvements. For example, the terminal may perform local pre-processing, such as spell correction, language detection, or character normalization, before transmitting description information. This local processing reduces server workload and decreases the amount of unnecessary data transferred, thereby reducing communication load. The terminal can also cache recent responses to allow offline viewing of advice information, reducing repeated requests and improving responsiveness.

Through these configurations, the server, the terminal, and the storage device cooperate to realize a technically specific implementation in which unstructured dream descriptions are systematically converted into prompt sentences, analyzed by a generative AI model, normalized into machine-interpretable state information, and utilized for trend-aware advice generation under strict anonymization and access-control constraints. This arrangement improves the efficiency, accuracy, and scalability of computer-implemented mental-state analysis and advice generation in a manner that is tightly coupled to the architecture and operation of the computing hardware and software components.

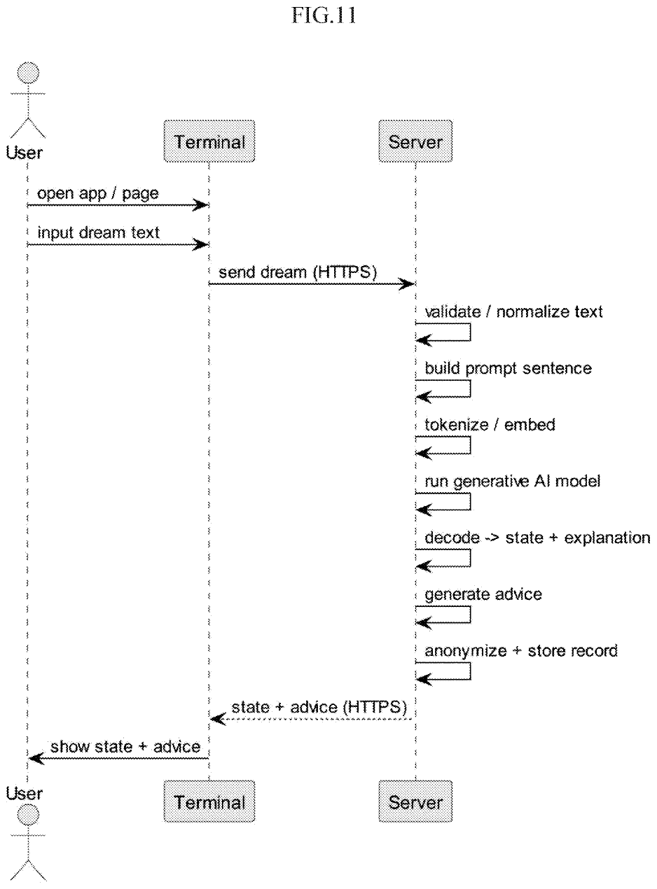

The following describes the processing flow using FIG. 11.

### Step 1:

The user operates the terminal to launch an application or open a web page that provides an interactive screen.

The terminal displays an input field and instruction text on a display unit.

[Input] The user views the interactive screen and types description information, for example: “Last night I dreamed that I was flying in the sky.”

[Processing] The terminal stores the entered text in an internal buffer (for example, a string variable in application memory).

[Output] The terminal holds a text string representing the dream description, ready to be transmitted to the server.

### Step 2:

The terminal prepares a request message to send the dream description to the server.

[Input] The terminal reads the buffered dream description and a locally stored pseudonymous user identifier.

[Processing] The terminal serializes these values into a structured payload (for example, a key-value map) and attaches protocol headers such as content type and authentication data. The terminal encapsulates the payload in a network message addressed to a server endpoint.

[Output] The terminal generates a complete network message including the dream description and user identifier, suitable for secure transmission.

### Step 3:

The terminal sends the network message to the server using a secure communication scheme.

[Input] The terminal takes the prepared network message and a destination address of the server.

[Processing] The terminal initiates a secure session using a transport-layer security protocol, performs a handshake to authenticate the server, and encrypts the payload. The terminal then transmits the encrypted message over a communication network.

[Output] The server receives an encrypted message containing the dream description and associated metadata.

### Step 4:

The server receives and parses the network message.

[Input] The server obtains the encrypted message from the network interface.

[Processing] The server terminates the secure session, decrypts the payload, and forwards the resulting data to an application layer. The server parses the headers to confirm format and authentication, and deserializes the payload to extract fields such as the pseudonymous user identifier and the dream description text.

[Output] The server produces internal data objects containing the raw dream description and associated user metadata.

### Step 5:

The server validates the dream description and prepares it for analysis.

[Input] The server takes the dream description text and user metadata from internal data objects.

[Processing] The server checks that the text is non-empty, within length limits, and uses a supported character encoding. The server may apply normalization such as lowercasing, trimming whitespace, and converting full-width characters to half-width. The server logs validation results and discards or flags invalid input.

[Output] The server produces a cleaned dream description string that satisfies predefined validation rules.

### Step 6:

The server constructs a prompt sentence for a generative AI model.

[Input] The server receives the cleaned dream description string.

[Processing] The server inserts the dream description into a template designed for model inference. For example, the server generates:
“Analyze the following dream content and infer the user's current emotions and thoughts. Output (1) the inferred psychological state and (2) a short explanation. Dream: ‘Last night I dreamed that I was flying in the sky.’”

Alternatively, when the dream is “Last night in my dream, I was being chased by a huge wave.”, the server generates:
“Last night in my dream, I was being chased by a huge wave. Please infer my emotions and thoughts from this dream and explain what psychological state this might reflect.”

The server stores this text as analysis input data.

[Output] The server generates a prompt sentence string and associated analysis input data ready for tokenization.

### Step 7:

The server tokenizes the prompt sentence and generates numerical representations.

[Input] The server takes the prompt sentence string from analysis input data.

[Processing] The server applies a tokenizer associated with the generative AI model to split the string into symbol sequences (tokens). The server maps each token to a token identifier according to a predefined vocabulary and constructs an ordered list of token identifiers. The server then maps each token identifier to an embedding vector, constructs tensors representing the sequence and attention masks, and loads these tensors into memory accessible by a computing unit such as a CPU or GPU.

[Output] The server produces tensor objects containing numerical representations of the prompt sentence, suitable as input to the generative AI model.

### Step 8:

The server performs inference using the generative AI model.

[Input] The server receives the tensors representing the prompt sentence, together with model parameters stored in memory.

[Processing] The server executes a forward pass of a neural network architecture, for example a Transformer-based generative model, by computing multi-head self-attention, linear transformations, and activation functions layer by layer. The server calculates context-dependent hidden states for each token position and uses output layers to generate either token-level probabilities for text outputs or continuous values for emotional scores. The server may output both a natural-language description and structured scores for psychological dimensions such as anxiety, calmness, or stress.

[Output] The server produces model output in the form of token identifier sequences for generated text and numerical vectors representing inferred psychological state scores.

### Step 9:

The server decodes and structures the model output into state information and explanation information.

[Input] The server takes the token identifier sequences and numerical vectors produced by the generative AI model.

[Processing] The server decodes token identifiers into text using the tokenizer's decoding function, obtaining sentences such as “You may be feeling overwhelmed by responsibilities.” The server then parses the generated text to locate key phrases and labels, and maps them to internal categories, such as “overwhelmed” mapped to an internal code and associated with a specific dimension. The server normalizes numerical scores into a standardized range and combines the text explanation and scores into a data structure representing state information and explanation information.

[Output] The server generates structured state information indicating the user's psychological state and explanation information describing the inferred state.

### Step 10:

The server generates advice information based on the state information.

[Input] The server receives the state information and explanation information from the previous step.

[Processing] The server applies a rule set or decision logic to the normalized scores and categories. For example, if an anxiety score is above a threshold and the explanation indicates “pressure from work”, the server selects a rule that recommends stress-management techniques. The server constructs a natural-language advice message such as “Try scheduling short breaks during your workday and practicing deep breathing exercises before sleep.” In another implementation, the server builds a second prompt sentence, for example: “The user's dream analysis suggests increased anxiety related to work pressure. Generate a short, practical, non-clinical advice message to help the user manage this anxiety.” and provides it to the generative AI model, then refines the generated advice using filtering rules.

[Output] The server outputs advice information as a text string tailored to the inferred psychological state.

### Step 11:

The server anonymizes identification information and prepares a record for storage.

[Input] The server receives the pseudonymous user identifier, the cleaned dream description, the state information, and the advice information.

[Processing] The server applies irreversible transformation processing, such as a one-way hash, to the user identifier. The server applies attribute generalization to sensitive attributes (for example, converting an exact age to an age range). The server combines the transformed identifier (anonymous information), the dream description, state information, and advice information into a structured record. The server excludes direct identifiers such as name, email, or exact location from the record.

[Output] The server produces a storage record containing anonymous information, dream content, state information, and advice information.

### Step 12:

The server stores the record in a storage device.

[Input] The server takes the structured record prepared in the previous step.

[Processing] The server opens a connection to a storage subsystem, such as a relational or document database, and inserts the record into a data collection. The server writes the data to persistent media and updates indices over anonymous identifiers and time fields. The server logs the success or failure of the write operation and may trigger backup or replication mechanisms.

[Output] The server generates a persistent entry in the storage device that can be retrieved for later analysis.

### Step 13:

The server constructs a response message containing state information and advice information.

[Input] The server receives the current state information, explanation information, and advice information, and may also consult stored data for context if needed.

[Processing] The server selects fields suitable for immediate feedback, such as a concise psychological state summary and a single advice message. The server organizes these fields into a response structure, attaches status codes and headers, and serializes the structure into a format suitable for transmission.

[Output] The server produces a response message containing user-oriented state information and advice information ready to be sent to the terminal.

### Step 14:

The server sends the response message to the terminal over a secure communication scheme.

[Input] The server takes the serialized response message and the address or session information of the requesting terminal.

[Processing] The server initiates or reuses a secure transport session, encrypts the response message, and transmits the encrypted data through the network interface. The server monitors transmission status and handles potential errors or retries if necessary.

[Output] The terminal receives an encrypted response containing state information and advice information.

### Step 15:

The terminal receives and displays the state information and advice information.

[Input] The terminal obtains the encrypted response from the server.

[Processing] The terminal uses the secure communication protocol to decrypt the response, verifies message integrity and status, and deserializes the payload. The terminal extracts the psychological state description and the advice text. The terminal updates the interactive screen by rendering these texts in designated areas, such as a summary section and an advice panel.

[Output] The user views the displayed psychological state and advice on the terminal screen and can optionally provide further input or feedback.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional mental health support systems that process user text rely primarily on simple keyword matching, rule-based classification, or generic recommendation logic executed by a computer. Such systems often treat free-form dream descriptions as unstructured text and merely map detected keywords to fixed advice templates. As a result, these systems suffer from several technical limitations: they are unable to extract fine-grained emotional and stress-related features from complex natural language input, they do not systematically use accumulated user interaction data to adapt internal models, and they provide only coarse personalization despite operating on computing resources capable of higher-level processing.

From a computing technology standpoint, existing architectures typically pass raw or minimally processed text directly to basic classifiers or to generative models, leading to inefficient utilization of computational resources and suboptimal control of model behavior. In particular, the lack of a structured pipeline that includes: (i) robust text normalization and tokenization tailored for deep learning, (ii) numeric inference of emotional and stress indicators via a multilayer neural network, (iii) rule-based interpretation of those numeric indicators into explicit mental health state labels, and (iv) controlled construction of a prompt sentence for a generative model, results in higher processing latency, unstable output quality, and difficulty in maintaining predictable system behavior.

Furthermore, conventional systems often store user text and model outputs without consistent anonymization and fine-grained access control at the infrastructure level. This leads to technical challenges in safely reusing historical data for model retraining or prompt optimization. In practice, this either forces system designers to avoid using rich historical data, thereby limiting the ability of the system to improve over time, or requires manual and error-prone anonymization workflows outside the main processing pipeline. As a consequence, systems are unable to implement a closed-loop improvement mechanism in which the same computing platform both protects personal information and continuously optimizes deep learning parameters and prompt construction logic based on anonymized usage data.

In addition, while generative AI models have the capability to produce nuanced advice, naive integration that simply forwards raw user input to such models can cause unnecessary computational load, unpredictable outputs, and inconsistent alignment with the intended support objective. Without a dedicated mechanism that programmatically constructs prompt sentences using structured analysis results and explicit instruction statements, the generative model may not focus on the relevant emotional and stress factors, and the system cannot reliably control output style, length, or content scope, which ultimately degrades the technical performance of the overall computing system.

Accordingly, there is a need for a computer-implemented system that technically improves the way a processor handles user dream text by: (1) converting the text into structured numeric representations suitable for deep learning, (2) producing explicit, machine-interpretable mental health state labels from model outputs through deterministic logic, (3) generating prompt sentences that guide a generative AI model in a controlled and context-aware manner, and (4) performing integrated anonymization and access control so that historical data can be safely used to update both the deep learning model and the prompt construction conditions. Such a system should improve the consistency, efficiency, and controllability of the computer's operation in processing natural language dream content and generating personalized advice.

The specific processing by the specific processing unit 290 of the data processing device 12 in Application Example 1 is realized by the following means.

The present invention provides a server comprising a processor and a memory storing instructions which, when executed by the processor, cause the server to provide a user interface on an information input/output device to receive dream contents as character information from a user, to normalize and tokenize the character information and convert a result of the tokenization into a numerical sequence, to execute a deep learning model including a multilayer neural network using the numerical sequence so as to generate an analysis result including numerical emotional state information and numerical stress index information, to perform threshold determination or rule-based determination on the analysis result so as to identify a mental health state including a dominant emotion, a stress level, and a classification category of the dream contents, to construct a prompt sentence including an instruction statement based on the dream contents and the identified mental health state and to input the prompt sentence to a generative information processing model so that the generative information processing model generates, in a controlled natural language format, an advice sentence, to output the advice sentence to the user via the user interface, and to perform anonymization processing on the dream contents, the analysis result, and the advice sentence by removing or replacing personal identification information and storing resulting anonymized information in a storage device, and further cause the server to use anonymized dream contents and corresponding analysis results stored over a predetermined period to update parameters of the deep learning model and conditions for constructing the prompt sentence, and to control access rights to information stored in the storage device according to user attributes or processing purposes. This enables the computer system to implement a structured and technically controlled processing pipeline for dream-based text input, in which free-form text is converted into machine-usable numeric features, mental health states are deterministically derived and encoded, prompt sentences are programmatically generated to guide a generative AI model, and anonymized historical data is safely reused to adapt model parameters and prompt construction logic, thereby improving the consistency, efficiency, and predictability of the computer's operation in analyzing dream content and generating personalized mental health advice.

The term “system” refers to an arrangement including at least one processor and at least one memory, and optionally including one or more input/output devices and communication interfaces, that cooperatively execute programmed instructions to perform the claimed processing.

The term “server” refers to an information processing apparatus, typically including a processor, a memory, and a communication interface, that provides computational services and data processing functions to one or more external devices via a communication network.

The term “processor” refers to a hardware arithmetic and logic unit, such as a central processing unit or graphics processing unit, or a combination thereof, that executes machine-readable instructions to perform operations specified in the claims.

The term “memory” refers to a hardware storage medium, such as a semiconductor memory, magnetic storage, or optical storage, or a combination thereof, that stores instructions and data used by the processor.

The term “information input/output device” refers to a hardware device, such as a display, a touch panel, a keyboard, a pointing device, a speaker, or a microphone, or a combination thereof, that enables presentation of information to a user and reception of information from the user.

The term “user interface” refers to a logical configuration of visual, auditory, or tactile elements presented on an information input/output device that allows a user to input data and receive output from the system.

The term “display area” refers to a region of a user interface in which information, such as text, icons, or graphical elements, is visually presented to a user.

The term “character input area” refers to a region of a user interface, such as a text box or editable field, that accepts character-based input from a user through a keyboard, touch panel, or other input mechanism.

The term “dream contents” refers to text-based information describing experiences, events, or images recalled by a user from a sleep state and entered as character information into the system.

The term “character information” refers to data composed of characters, symbols, or code points representing textual content that can be processed by a computer.

The term “preprocessing” refers to a series of processing operations applied to raw character information prior to input into a machine learning model, including at least normalization of character strings and division into smaller units.

The term “character string normalization” refers to processing that converts character information into a standardized form, including operations such as conversion of character types, unification of whitespace, or normalization of encoding.

The term “morpheme units or symbol units” refers to minimal linguistic or symbolic elements obtained by dividing a character string, including words, subwords, morphemes, punctuation marks, or other symbol-level tokens.

The term “tokenization” refers to processing that divides a character string into morpheme units, symbol units, or other tokens suitable for further numerical encoding.

The term “numerical sequence” refers to an ordered set of numerical values, such as token identifiers, embeddings, or feature vectors, derived from character information and suitable for input to a machine learning model.

The term “deep learning model” refers to a machine learning model including multiple computational layers, such as fully connected layers, convolutional layers, or attention layers, that is trained to map input data to output data through learned parameters.

The term “multilayer neural network” refers to a computational structure including an input layer, one or more hidden layers, and an output layer, wherein each layer comprises nodes connected by weighted edges whose values are adjusted through learning.

The term “analysis result” refers to data generated by processing dream contents with a deep learning model, including at least numerical information that estimates or describes an emotional state and a stress index for the user.

The term “numerical emotional state information” refers to one or more numerical values that represent degrees or probabilities associated with one or more emotion categories, such as anxiety, sadness, anger, or calmness.

The term “numerical stress index information” refers to one or more numerical values that represent an estimated level of psychological stress experienced by a user, calculated from outputs of the deep learning model.

The term “threshold determination” refers to processing in which a numerical value is compared with one or more predetermined threshold values to classify the value into discrete categories, such as high, medium, or low.

The term “rule-based determination” refers to processing in which one or more logical rules, defined independently of model parameters, are applied to input data such as numerical emotional state information and numerical stress index information to derive a classification or label.

The term “mental health state” refers to structured information representing a user's psychological condition, including at least a dominant emotion, a stress level, and a classification category of the dream contents.

The term “dominant emotion” refers to an emotion category selected as primary based on comparison among multiple emotion-related scores in the analysis result.

The term “stress level” refers to a qualitative or quantitative classification of stress, such as high, medium, or low, derived from the numerical stress index information by threshold determination or rule-based determination.

The term “classification category of the dream contents” refers to a label that assigns the dream contents to one of a plurality of predefined categories, such as performance-related, relationship-related, or safety-related, based on analysis of the contents.

The term “prompt sentence” refers to a text sequence that includes at least an instruction statement and context information, constructed to be input to a generative information processing model in order to control the content and style of generated output.

The term “instruction statement” refers to a portion of a prompt sentence that explicitly describes a task or output requirement to be performed by a generative information processing model.

The term “generative information processing model” refers to a machine learning model, such as a generative language model, that generates new text data in a natural language based on an input prompt sentence and internal parameters.

The term “advice sentence” refers to natural language text generated by the generative information processing model, providing suggestions or recommendations intended to support improvement of a user's mental health state.

The term “anonymization processing” refers to processing that removes, masks, or replaces information capable of identifying a specific individual from stored data so that the individual cannot be directly identified.

The term “personal identification information” refers to information that can identify a specific individual, such as name information, geographic information, contact information, or combinations thereof.

The term “storage device” refers to a hardware device, such as a semiconductor memory, magnetic disk, or optical disk, configured to store data, including anonymized dream contents, analysis results, and advice sentences.

The term “anonymized information” refers to information from which personal identification information has been removed or replaced so that the information cannot be associated with a specific individual using reasonable means.

The term “statistical processing” refers to processing that aggregates and analyzes multiple records of anonymized information to derive numerical summaries, distributions, or trends.

The term “learning processing” refers to processing that updates parameters of a machine learning model or related configuration values based on training data, including anonymized dream contents and analysis results.

The term “parameters of the deep learning model” refers to internal numerical values, such as weights and biases of a neural network, that determine the behavior of the deep learning model and are subject to adjustment during learning processing.

The term “conditions for constructing the prompt sentence” refers to rules, templates, or configuration values that determine the structure, content, language, or style of a prompt sentence generated by the system.

The term “optimized advice sentence” refers to an advice sentence generated using updated model parameters or updated prompt construction conditions, such that the advice sentence is better aligned with a user's mental health state according to a predetermined objective.

The term “name information” refers to character strings representing personal names, such as given names, family names, or full names, that can contribute to identification of an individual.

The term “geographic information” refers to character strings representing locations, such as addresses, city names, region names, or facility names, that can contribute to identification of an individual.

The term “contact information” refers to character strings representing communication identifiers, such as telephone numbers, electronic mail addresses, or user account identifiers, that can contribute to identification of an individual.

The term “character string pattern determination” refers to processing that uses pattern matching, such as regular expressions, to identify character strings conforming to predefined formats of personal identification information.

The term “natural language processing-based identification information detection” refers to processing that applies a natural language processing technique, such as named entity recognition, to detect entities corresponding to personal identification information in text.

The term “generalized substitute symbols” refers to replacement tokens, such as generic labels or placeholders, used to substitute for personal identification information so that the specific original values are not retained.

The term “access control processing” refers to processing that determines whether a request for reading or writing information stored in a storage device is permitted, based on access rights associated with a user attribute or a processing purpose.

The term “user attribute” refers to information associated with a user or process, such as role, permission level, or group membership, used to determine access rights to information.

The term “processing purpose” refers to a declared or inferred objective of processing stored information, such as providing user feedback, performing model training, or conducting statistical analysis, used as a factor in access control.

In one embodiment, a server, a terminal, and a user cooperate to implement the claimed system. The server includes at least one processor, a main memory, a non-volatile storage device, and a network interface. The terminal includes a display, an input unit such as a touch panel or keyboard, a communication unit, and a local processor. The user operates the terminal to input dream contents, receive analysis results, and view advice.

The server executes a program stored in the memory to implement the functions defined in the claims. The server uses a general-purpose operating system, a web server, an application server, and a machine learning framework. For example, the server uses a UNIX-like operating system, a web server, an application framework that runs on the operating system, and a deep learning framework such as a numerical computation library with GPU support. The server stores trained neural network parameters and configuration files in the storage device.

The terminal executes a client-side application. The terminal uses a browser or native application framework to render a user interface. The user sees, on the display of the terminal, a user interface provided by the server. The user interface includes a display area for showing text and a character input area for entering dream contents. The user uses the input unit to input dream contents as character information. The terminal converts the input into a structured request and sends the request through the communication unit to the server via a network.

The server receives the request containing the dream contents and associated metadata. The server stores the request in the memory in an internal data structure, such as an object or record that includes fields for a request identifier, a timestamp, the raw character string of the dream contents, optional user preference flags, and language settings. The server then performs preprocessing on the dream contents.

The server performs character string normalization on the dream contents. The server converts characters to a normalized encoding form, unifies full-width and half-width variants, removes or compresses repeated whitespace characters, and normalizes line breaks. The server then performs tokenization. The server divides the normalized character string into morpheme units or symbol units, depending on the language. For example, the server uses a tokenizer library compatible with a deep learning language model to segment the text into tokens. The server converts each token into a numeric identifier based on a vocabulary table stored in the storage device. The server thereby generates a numerical sequence representing the dream contents. The server may also generate auxiliary data such as an attention mask and segment indicators, and stores these in fixed-length numerical arrays to be input to the deep learning model.

The server loads, from the storage device, a deep learning model including a multilayer neural network. In one embodiment, the deep learning model has an embedding layer, a plurality of hidden layers, and an output layer. The embedding layer maps token identifiers into dense vectors. The hidden layers may include recurrent units, convolutional units, or attention-based units, such as a multi-head attention mechanism, together with nonlinear activation functions and normalization layers. The output layer transforms a hidden representation into numerical values corresponding to emotion-related scores and stress-related indices.

The server executes the deep learning model on a hardware accelerator when available. For example, the server uses a graphics processing unit to perform matrix multiplications, vector operations, and activation computations in parallel. The server transfers the numerical sequence and associated masks from system memory to device memory of the accelerator. The server then commands the deep learning framework to compute the forward pass of the model. This arrangement improves processing speed compared with a purely sequential implementation on a central processing unit, and enables the server to process longer and more complex dream contents within practical latency.

The server obtains, as an analysis result, numerical emotional state information and numerical stress index information. For example, the server computes an emotion probability vector, where each element corresponds to an emotion class such as anxiety, sadness, anger, calmness, or other states. The server computes a stress index value or a set of values representing overall stress level and possibly sub-dimensions such as performance stress or interpersonal stress. The server stores these numerical values in the memory in association with the request identifier.

The server performs threshold determination and rule-based determination on the analysis result. In one embodiment, the server compares each numerical value representing an emotion probability with one or more threshold values stored in a configuration file. The server identifies a dominant emotion as the emotion whose probability exceeds a threshold and is maximum among the candidates. The server also classifies the stress level into categories, such as low, medium, or high, based on threshold comparisons of the numerical stress index. Additionally, the server assigns a classification category of the dream contents, such as performance-related, relationship-related, or safety-related, by applying rules that reference both the numeric scores and specific token patterns extracted from the dream text. For example, the server may use a rule stating that if words related to evaluation, examination, or performance co-occur with high anxiety and high stress index, the classification category is assigned as performance-related. These rules are stored as machine-readable rule sets in the storage device and executed deterministically by the processor.

The server constructs a mental health state record including at least the dominant emotion, the stress level, and the classification category. The server maintains this record in a structured format, such as a key-value mapping, so that subsequent processing modules can reference specific elements without re-parsing the text. This explicit structuring improves internal communication between modules and allows consistent, low-overhead access to analysis results, which contributes to reduced overall processing latency.

The server constructs a prompt sentence to be input to a generative AI model. The server uses the dream contents and the mental health state as primary inputs. The server selects a prompt template from the storage device according to language settings and user preferences. The server then inserts into the template both the original dream text and a textual description of the detected mental health state. For example, the server constructs a prompt sentence such as:
“Dream content: Last night, I had a dream that I failed an important exam.
Analysis result: The user shows high anxiety and a high stress level related to performance.
Task: As a mental health support assistant, generate specific, practical, and empathetic advice to help the user manage performance anxiety and reduce stress. Use clear and supportive language.
Keep the answer concise (about 3-6 sentences).”

In another example, the server constructs a prompt sentence in another language, such as:
“Dream content: Last night, I had a dream that I failed an exam.
Analysis result: The user is estimated to have strong performance-related anxiety and a high level of stress.
Based on this analysis result, please generate concrete and practical advice, in Japanese, that would help improve the user's mental health.
Please place emphasis on methods for reducing stress and on emotional support.”

In a further embodiment, the server constructs a prompt sentence that explicitly includes numeric scores, such as:
“Dream content (user input): Last night, I had a dream that I failed an important exam.
Model scores: anxiety=0.88, sadness=0.60, anger=0.10, calmness=0.05, overall_stress_level=0.85.
Task: Using these scores and the dream content, generate personalized mental health advice.
Provide short, actionable steps for coping with performance anxiety and managing stress in daily life.”

The server thereby implements a controlled prompt-construction process in which machine-interpretable numeric outputs and rule-based labels are transformed into a prompt sentence. This method differs from simple forwarding of user text to a model because it imposes explicit structure and constraints on the generative AI model. As a result, the system improves stability and predictability of the generated advice, and reduces the need for manual curation.

The server sends the prompt sentence to a generative AI model. The generative AI model may reside on the same server, on a separate hardware device under the same administrative control, or on an external computing service accessible through the network. The generative AI model typically uses a transformer-based neural network with multiple layers of self-attention, feed-forward layers, and learned embeddings. The server encodes the prompt sentence into tokens compatible with the generative model and transmits the encoded prompt and generation parameters such as maximum output length and randomness control values. The generative AI model processes the prompt and generates an advice sentence in natural language. The server receives the generated text and stores it in association with the corresponding request identifier.

The server optionally applies post-processing to the advice sentence. The server trims extraneous whitespace, checks length limits, and, if desired, applies rule-based filtering to avoid including disallowed phrases or to enforce specific stylistic constraints. Because the server controls both the prompt content and the post-processing, the overall computer-implemented pipeline yields more consistent advice than a configuration in which a generative model is asked to infer all tasks from free-form user input.

The server sends the final advice sentence and optionally a summary of the mental health state to the terminal. The terminal receives the information and displays the advice in the display area of the user interface. The user reads the advice and can use it for mental health support. The terminal may also display simplified icons or color-coded indicators corresponding to the stress level, which helps the user understand the analysis result at a glance.

The server performs anonymization processing before storing detailed data in the storage device. The server analyzes the dream contents, the analysis result, and the advice sentence to detect personal identification information. The server uses pattern-based detection, such as regular expressions for telephone number formats or email patterns, and natural language processing-based identification, such as named entity recognition, to detect names of persons, geographic locations, and contact information. The server replaces detected personal identification information with generalized substitute symbols, such as “[NAME]”, “[LOCATION]”, or “[CONTACT]”. The server writes the anonymized dream text, the numerical emotion scores, the stress indices, the mental health state labels, and the advice sentence into a database table or other structured storage. By integrating anonymization into the processing pipeline, the server reduces the risk of storing identifiable information and enables safe reuse of data for model improvement.

The server implements access control processing over the stored information. The server associates each stored record with access control metadata that encodes permitted processing purposes and required user attributes. When an application component or an administrative tool attempts to read or modify stored data, the server checks the calling context against access control rules. The server allows, for example, only aggregate access to anonymized records for training and evaluation purposes, and restricts direct access to raw input or intermediate internal identifiers. This fine-grained control reduces the chance of unauthorized access and aligns the system operation with privacy constraints, while still allowing efficient use of the stored data for technical improvement of the models.

The server uses anonymized dream contents and corresponding analysis results stored over a predetermined period for learning processing. The server periodically loads batches of historical records and uses them as training data to update the parameters of the deep learning model. The server defines a loss function, such as cross-entropy or mean squared error, based on target labels or self-supervised objectives derived from the data. The server applies an optimization algorithm, such as gradient descent with adaptive learning rates, to compute gradients of the loss with respect to model parameters and updates the parameters accordingly. The server may use data augmentation techniques, such as random masking of tokens or synonym replacement, to increase robustness. By performing this training on anonymized data, the server improves the accuracy and generalization capability of the deep learning model without directly handling identifiable information.

The server also updates conditions for constructing the prompt sentence. The server keeps configuration data specifying template structures, phrase patterns, and mapping rules from mental health state labels to textual descriptions. The server evaluates performance of different templates based on objective measures such as user engagement metrics, length conformity, or external evaluator scores. The server then adjusts the template selection rules, ordering of information, or emphasis of particular emotional factors. This process enables the server to refine the prompt construction logic over time, leading to more efficient and targeted utilization of the generative AI model. Because the prompt sentence is constructed based on machine-structured internal state rather than raw text alone, these improvements translate into better control of generative behavior and reduced computational overhead.

The described configuration yields several technical effects. By normalizing and tokenizing the dream contents and converting them into a numerical sequence optimized for neural network input, the server reduces the variability in input representation and allows the deep learning model to converge faster and operate more efficiently. By explicitly separating numeric inference (via the deep learning model) from symbolic reasoning (via rule-based determination), the server can implement clear decision boundaries, simplify debugging, and reduce error propagation. This modularization, combined with GPU-accelerated computation, improves processing throughput and reduces latency.

By constructing structured prompt sentences that incorporate both raw content and explicit mental health state labels, the server reduces ambiguity for the generative AI model. This arrangement decreases the need for long or repeated prompts, thereby reducing communication bandwidth and inference time at the generative model. In addition, the server's ability to tune templates and parameters based on accumulated anonymized data provides a feedback loop that improves computer performance over time, beyond a simple one-time configuration.

By integrating anonymization and access control into the core processing path, the server can safely maintain rich historical datasets without manual intervention. This allows continuous retraining and optimization within the same system infrastructure, improving model accuracy and robustness while maintaining compliance with privacy constraints. In this way, the system improves the way computers manage sensitive user text data, not merely automating a human administrative task.

Alternative embodiments are possible. The server may use different neural network architectures, such as a recurrent neural network with gated units, a convolutional network for local pattern extraction, or a hybrid model combining recurrent and attention components. The server may represent the dream contents using character-level embeddings, byte-level embeddings, or subword-level embeddings instead of word-level tokens. The server may use different rule sets for determining the mental health state, including decision trees or logic rule engines. The generative AI model may be hosted locally or remotely, may be fine-tuned on domain-specific data, or may be replaced by another generative architecture that produces multi-sentence advice.

The terminal may be a smartphone, a tablet, a personal computer, or a dedicated console. The user interface may be implemented as a native application, a web application, or a hybrid application. Multiple servers may be arranged in a cluster, where one server handles preprocessing and deep learning inference, another server manages prompt construction and interaction with the generative model, and a further server manages storage and training operations. These variations remain within the scope of the invention so long as the system implements the key features: structured conversion of dream text into numeric features, rule-based derivation of mental health state, construction of a controlled prompt sentence for a generative AI model, integrated anonymization and access control, and use of anonymized historical data for updating model parameters and prompt construction conditions.

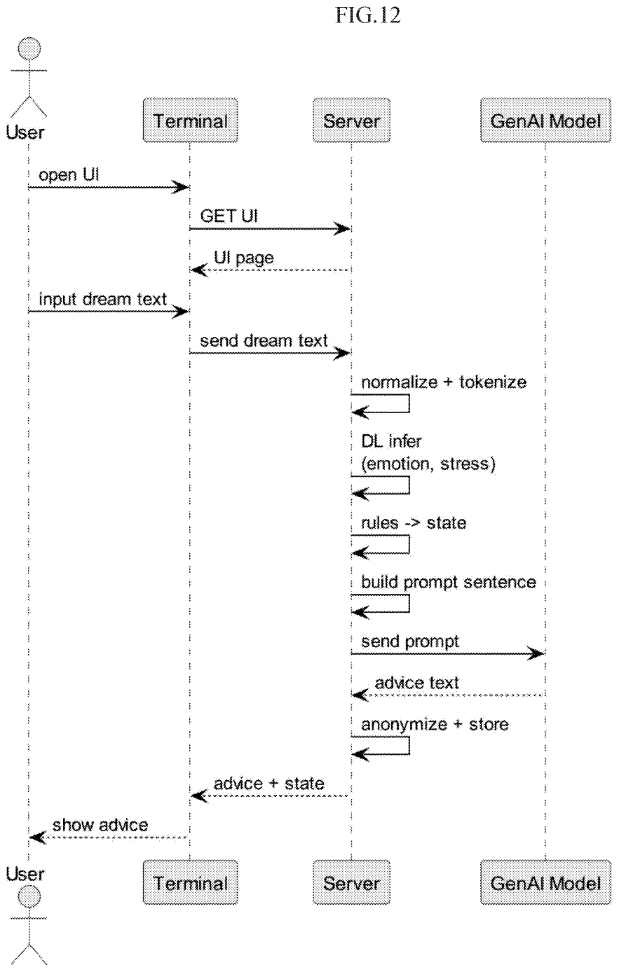

The following describes the processing flow using FIG. 12.

### Step 1:

User operates the terminal to launch an application or open a web page and views a user interface including a display area and a character input area.

Input: No prior system data; the terminal loads UI resources from the server.

Output: A rendered input screen on the terminal, ready to accept dream contents.

### Step 2:

User inputs dream contents as character information into the character input area using a touch panel, keyboard, or similar input device.

Input: User's keystrokes or touch gestures representing the dream contents.

Output: A raw character string (for example, “Last night, I had a dream that I failed an important exam.”) stored in the terminal's memory.

### Step 3:

Terminal packages the raw character string and metadata (such as a local timestamp and language setting) into a structured request and transmits the request to the server via a communication interface using a network protocol.

Input: Raw character string and local metadata.

Output: A network message containing the dream text and metadata, formatted for example as a structured record, sent to the server.

### Step 4:

Server receives the network message, parses the structured request, and stores the dream contents and metadata in a temporary internal data structure in main memory.

Input: Network message containing the raw character string and metadata.

Output: An internal record including fields for request identifier, timestamp, raw dream text, and language setting.

### Step 5:

Server performs character string normalization on the raw dream text by unifying character encodings, removing redundant whitespace, and normalizing punctuation and line breaks.

Input: Raw dream text from the internal record.

Output: A normalized character string that is syntactically consistent and prepared for tokenization.

### Step 6:

Server performs tokenization on the normalized character string by dividing it into morpheme units or symbol units and mapping each unit to a numeric token identifier using a predefined vocabulary table.

Input: Normalized character string and a vocabulary table stored in the storage device.

Output: A numerical sequence of token identifiers and associated masks (for example, attention masks) suitable for input to a deep learning model.

### Step 7:

Server loads a deep learning model including a multilayer neural network from the storage device into memory and transfers the numerical sequence and masks to a computation device such as a graphics processing unit.

Input: Numerical token sequence and masks, and a stored deep learning model definition with learned parameters.

Output: Prepared model input tensors and an initialized model instance ready for inference on the computation device.

### Step 8:

Server executes a forward pass of the deep learning model on the computation device to transform the numerical token sequence into hidden representations and then into numerical emotional state information and numerical stress index information.

Input: Model input tensors (numerical token sequence and masks) and the model parameters.

Output: An analysis result including, for example, emotion probability scores for multiple emotion classes and one or more stress index values.

### Step 9:

Server performs threshold determination and rule-based determination on the analysis result by comparing each emotion score and stress index against stored threshold values and applying predefined logical rules.

Input: Emotion probability scores, stress index values, and configuration data defining thresholds and rules.

Output: A mental health state record including a dominant emotion, a stress level category (such as low, medium, high), and a classification category of the dream contents.

### Step 10:

Server constructs a prompt sentence by selecting a template based on language and user settings, inserting the original dream contents and the derived mental health state into the template, and forming a complete textual instruction for a generative AI model.

Input: Original normalized dream text, mental health state record, and prompt template configuration.

Output: A prompt sentence, such as:
“Dream content: Last night, I had a dream that I failed an important exam.
Analysis result: The user shows high anxiety and a high stress level related to performance.
Task: As a mental health support assistant, generate specific, practical, and empathetic advice to help the user manage performance anxiety and reduce stress. Use clear and supportive language.
Keep the answer concise (about 3-6 sentences).”

### Step 11:

Server sends the constructed prompt sentence and generation parameters (such as maximum output length and randomness settings) to a generative AI model residing locally or on a remote computing resource and requests generation of an advice sentence.

Input: Prompt sentence and generation parameters.

Output: A call to the generative AI model and an in-progress request awaiting a generated advice sentence.

### Step 12:

Server receives from the generative AI model a generated advice sentence in natural language and stores the advice sentence in association with the corresponding request identifier.

Input: Generated text output from the generative AI model.

Output: An advice sentence string stored in the server's memory and linked to the dream contents and mental health state record.

### Step 13:

Server optionally performs post-processing on the advice sentence by trimming extraneous whitespace, verifying that the length and content satisfy predefined constraints, and, if necessary, filtering or adjusting phrases according to rule-based policies.

Input: Raw advice sentence from the generative AI model and post-processing rules.

Output: A finalized advice sentence that conforms to system policies and presentation constraints.

### Step 14:

Server prepares a response including the finalized advice sentence and, optionally, part of the mental health state (such as the stress level and dominant emotion) and transmits the response to the terminal via the network.

Input: Finalized advice sentence and mental health state record.

Output: A network message containing the advice and optional summary data destined for the terminal.

### Step 15:

Terminal receives the response, parses the contained data, and updates the user interface to display the advice sentence and any additional indicators, such as a visual representation of the stress level.

Input: Network message containing the advice sentence and summary data.

Output: A rendered advice display on the terminal's screen, visible to the user.

### Step 16:

Server performs anonymization processing on the dream contents, the analysis result, and the advice sentence by detecting personal identification information using pattern matching and natural language processing and replacing such information with generalized substitute symbols.

Input: Raw dream text, analysis results, and advice sentence strings.

Output: An anonymized record in which names, locations, contact details, and similar identifiers are removed or replaced with generic placeholders.

### Step 17:

Server writes the anonymized record, including the anonymized dream text, numerical emotion scores, stress indices, mental health state labels, and advice sentence, into a structured storage device under controlled access permissions.

Input: Anonymized record data and storage configuration.

Output: A stored entry in a database or file system, tagged for later retrieval and restricted access.

### Step 18:

Server periodically retrieves a collection of anonymized records from the storage device and uses them as training data for learning processing to update parameters of the deep learning model and to refine conditions for constructing the prompt sentence.

Input: Batches of anonymized dream contents, associated analysis results, and stored configuration values.

Output: Updated model parameters and updated prompt construction conditions that are written back to the storage device and applied in subsequent executions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented mental health support systems that process user text rely on fixed rule sets or direct application of machine learning models to raw input data. Such systems typically analyze single, isolated inputs without effectively incorporating structured historical context, and they often produce generic, non-personalized advice. As a result, these systems suffer from limited accuracy in estimating a user's psychological state, poor adaptability to changes over time, and inadequate personalization of recommendations. Furthermore, existing architectures generally pass user text directly to a model without an intermediate representation tailored to the model's reasoning capabilities. In particular, conventional systems do not systematically generate prompt sentences that explicitly encode both current input and statistically processed historical indicators, nor do they numerically express psychological state information in a way that can be iteratively refined by the system. This leads to inefficient use of computational resources, unstable output quality from generative AI models, and difficulty in tracking and optimizing mental health guidance over time.

In addition, many conventional implementations lack robust feedback loops and do not structurally integrate user evaluations or feedback into the processing pipeline. Without a mechanism for capturing and exploiting evaluation information, the system cannot adaptively optimize future advice or adjust prompt generation logic, thereby limiting the technical performance and learning capability of the overall system.

There is also a technical challenge in maintaining user privacy and data security while still exploiting accumulated data to improve analysis accuracy. Systems that do not tightly couple access control, encryption, and data linkage mechanisms risk either exposing sensitive information or underutilizing stored data. This tension leads to suboptimal system design, where privacy and analytical performance are not jointly optimized in a coherent architecture.

Accordingly, there is a need for an improved computer-implemented system and method that: (i) generates structured prompt sentences for a generative AI model based on both new dream content and statistically processed numerical history, (ii) converts model-output psychological state information into persistent numerical indicators for longitudinal analysis, (iii) customizes advice using both history and user feedback to adaptively optimize future outputs, and (iv) integrates these operations with privacy-preserving storage and access control. Such a system should improve the technical functioning of the server-side processing pipeline, including data structuring, model interaction, and iterative optimization, rather than merely providing a different presentation of information to the user.

The specific processing by the specific processing unit 290 of the data processing device 12 in Example 2 is realized by the following means.

The present invention provides a server comprising a processor and a storage device, the processor being configured to cause a terminal to present an interface through which a user inputs dream content as character-based information, to receive the dream content from the terminal, to generate a structured prompt sentence based on the received dream content and history information associated with the user, to input the prompt sentence into a generative AI model and to obtain analysis result information including psychological state information and advice information produced by natural language processing performed by the generative AI model, to express the psychological state information as numerical information and store the numerical information in the storage device in association with the dream content and the history information, to calculate changes in psychological state over time based on numerical information stored for a plurality of time points and to generate history summary information, to generate a further prompt sentence including the history summary information and to input the further prompt sentence into the generative AI model to improve accuracy of subsequent analysis result information, to generate customized advice information by selecting and adjusting the advice information in accordance with an individual situation of the user, to transmit the customized advice information to the terminal for presentation to the user, to acquire evaluation information or feedback information from the terminal regarding the customized advice information and store the evaluation information or the feedback information in the storage device, and to adaptively modify at least one of the prompt sentence generation processing and the customized advice generation processing based on the stored evaluation information or feedback information, while performing access control and encryption on stored information including the dream content, the analysis result information, the numerical information, and the customized advice information. This enables an improved computer-implemented processing pipeline in which the server structures input data into model-optimized prompt sentences, persistently numericalizes psychological state indicators for longitudinal computation, iteratively refines interaction with the generative AI model using statistically derived history and user feedback, and securely manages associated data, thereby enhancing the technical performance, stability, and adaptability of mental-health-related analysis and advice generation executed by the server.

The term “terminal” refers to an information processing apparatus operated by a user, such as a general-purpose computing device or communication device, that is configured to present an interface, receive user input, and transmit and receive data to and from a server over a communication network.

The term “user” refers to a human individual who operates a terminal to input dream content, receive analysis results and advice, and optionally provide evaluation or feedback information to the system.

The term “dream content” refers to character-based information that describes events, scenes, thoughts, or feelings experienced by a user during sleep, and that is input by the user via an interface provided on the terminal.

The term “character-based information” refers to data represented as a sequence of textual symbols in a natural language, such as letters, numbers, punctuation, and spaces, which can be processed as a string by a computer system.

The term “interface” refers to a presentation and input mechanism provided on a terminal, including one or more display components and input components, that enables a user to enter dream content and other information and to receive information from a server.

The term “history information” refers to information associated with a user and stored over time, including at least past dream content, past analysis result information, and numerical information derived from such analysis, which is used to provide context for subsequent processing.

The term “prompt sentence” refers to a structured text expression generated by the processor that includes at least part of the dream content and history information, and that is formatted to instruct a generative AI model to perform a specified analysis or generation task.

The term “generative AI model” refers to a machine learning model configured to generate natural language or other data outputs in response to input text, the model having been trained on large amounts of data and being capable of performing natural language processing, analysis, and content generation.

The term “analysis result information” refers to information output from the generative AI model in response to a prompt sentence, including at least psychological state information related to the dream content and advice information based on the psychological state information.

The term “psychological state information” refers to information indicative of a user's mental or emotional condition inferred from the dream content, such as stress, anxiety, mood, or other mental states.

The term “advice information” refers to information representing suggested actions, coping strategies, or behavioral or cognitive recommendations generated to support or improve a user's mental or emotional condition.

The term “numerical information” refers to information in which at least part of the psychological state information is represented as a numerical value, such as a score or index, that can be compared, aggregated, or statistically processed over time.

The term “storage device” refers to a hardware or logical data storage resource, such as a memory device, database system, or storage subsystem, that is configured to store dream content, history information, analysis result information, numerical information, advice information, and other related data.

The term “history summary information” refers to information generated by processing history information and numerical information for a plurality of time points, the information summarizing temporal changes or patterns in a user's psychological state or dream characteristics.

The term “customized advice information” refers to advice information that has been selected, modified, or generated based on at least numerical information, history information, and user-specific conditions, such that the advice is adapted to an individual situation of the user.

The term “display information” refers to information formatted by the processor or terminal into a representation suitable for visual or other sensory presentation to a user through an output component of the terminal.

The term “evaluation information” refers to information indicating an assessment by a user of the usefulness, appropriateness, or satisfaction with respect to customized advice information, including but not limited to ratings, selections, or binary indicators.

The term “feedback information” refers to information provided by a user that describes a reaction, comment, or additional context regarding customized advice information, which may include free-form text or structured responses.

The term “access control” refers to a set of technical processes by which the system restricts reading, writing, or modification of stored information to authorized processes, components, or entities according to predetermined conditions or rules.

The term “encryption processing” refers to a process of transforming data using a cryptographic algorithm and key such that the data is rendered unintelligible to unauthorized entities and can be restored to its original form only by entities possessing appropriate decryption information.

The term “natural language processing” refers to a set of computational techniques used by the generative AI model to interpret, analyze, and generate human language in textual form based on input data.

The term “analysis target” refers to content, such as dream content and associated information, that is explicitly designated within a prompt sentence as subject matter to be interpreted, evaluated, or processed by the generative AI model.

The term “individual situation of the user” refers to conditions specific to a particular user, including at least the user's historical psychological state, dream patterns, preferences, lifestyle constraints, or other user-related attributes stored as part of history information.

The term “generation processing of the prompt sentence” refers to processing performed by the processor to construct, format, and output a new prompt sentence using at least dream content, history information, and optionally history summary information, evaluation information, or feedback information.

The term “generation processing of the customized advice information” refers to processing performed by the processor to select, modify, or newly create advice information based on analysis result information, numerical information, history information, and at least one of evaluation information and feedback information.

In one embodiment, a server, a terminal, and a user cooperate to implement the invention.

The server includes at least one processor, a main memory, a non-volatile storage device, and a network interface. The server is implemented, for example, by a general-purpose computer system or a cloud computing instance executing an operating system such as a general-purpose server operating system. The server executes application software implemented using a web framework such as a general-purpose web framework in a programming language such as a general-purpose programming language. The server further communicates with a database system such as a relational database management system (for example, a database compatible with SQL) deployed either on the same physical machine or on a separate storage subsystem.

The terminal is implemented, for example, by a mobile communication device, a tablet device, a notebook computer, or a desktop computer. The terminal executes a client application, such as a native mobile application or a browser-based application implemented using HTML, CSS, and JavaScript. The terminal includes a display unit, an input unit such as a touch panel or keyboard, a local memory, and a communication module configured to access the server via a packet-switched network such as the Internet using a protocol such as HTTPS.

The user operates the terminal to input dream content. The terminal presents a graphical user interface generated either by native components or by a browser rendering an HTML form. The interface includes at least a text input field for the dream content and an activation component such as a button to submit the input. The terminal converts user keystrokes or touch input into character-based information in a selected natural language and prepares request data containing the dream content, timestamps, and authentication tokens. The terminal then transmits this data to the server through the network interface.

The server receives the character-based dream content via an application programming interface endpoint. The server authenticates the request using a security mechanism such as a token-based authentication scheme. The server associates the received dream content with a user identifier and stores the dream content in a structured record in the database. The record includes fields for the dream text, a creation timestamp, a user identifier, and optionally a language code and other metadata. The database uses a structured schema, for example a table with columns for primary key, user ID, dream text, analysis result, numerical score, and advice data. The server may also store this information in a column having a semi-structured data type, such as a JSON-capable column, in order to flexibly store nested analysis results.

The server manages history information by maintaining multiple such records per user. The server retrieves past records from the database when needed and performs statistical computations over numerical indicators stored in these records. For example, the server reads numerical stress scores from multiple records and computes an average, a maximum, a minimum, or a trend over time. The server may execute these computations using vectorized operations provided by a numerical computation library, thereby reducing processing time and improving scalability as the number of records increases.

The server uses the dream content and the history information to generate a prompt sentence adapted to a generative AI model. The generative AI model is, in one embodiment, a transformer-based neural network. The generative AI model includes an embedding layer that maps tokens to continuous vectors, multiple stacked self-attention layers that compute context-dependent representations of tokens, and one or more output layers that predict the next token or response content. The model has been trained on large-scale text corpora using a loss function such as cross-entropy loss and an optimization algorithm such as stochastic gradient descent with adaptive moment estimation. During training, model parameters such as weight matrices and bias vectors are iteratively updated based on gradients computed by backpropagation. The server accesses the generative AI model via a model-serving interface such as a REST API or a remote procedure call interface.

The server does not pass the raw dream text directly to the generative AI model. The server instead constructs a structured prompt sentence that explicitly defines the dream content as an analysis target, annotates it with numerical and statistical context, and instructs the model to output information in a machine-readable format. To achieve this, the server retrieves relevant history information, such as past stress scores and frequent dream themes, and generates a history summary sentence. The server then combines the history summary sentence with the latest dream content and instructions for output format.

In one example, the server generates a prompt sentence as follows:
“You are a psychologist analyzing dreams.
User history summary: Over the last 3 weeks, the user's reported stress scores have ranged from 6 to 8, with frequent dreams of being chased and difficulty escaping.
New dream:
‘Last night I had a dream that I was being chased and couldn't find a place to hide.’
Tasks:
1. Estimate the user's current stress level from 0 (no stress) to 10 (extreme stress).
2. Describe the emotional state in 2-3 sentences.
3. Provide 3-5 specific, practical recommendations to improve mental health.
Output the result in JSON with keys:
   stress_score (number),
   emotional_state_summary (string),
   advice (array of strings).”

The server may alternatively construct a different prompt sentence tailored to refinement of advice using feedback. For example, the server may generate:
“User profile: 35-year-old office worker with high workload and limited free time.
Recent analysis summary: The user's stress level has been between 7 and 9 for the last month.
Base advice:
1. Practice deep breathing for 10 minutes twice a day.
2. Take a 30-minute walk in nature every day.
3. Write a daily journal before sleep.

Rewrite these recommendations in simple, encouraging language suitable for a busy office worker with limited free time, making the suggestions realistic and concrete, and keeping the total length under 250 words.”

The server formats these prompt sentences according to an interface specification of the generative AI model, for example by embedding the prompt as a content string parameter. The server then transmits the prompt sentence to the generative AI model through the network interface using an encrypted communication protocol. The generative AI model executes inference on specialized hardware such as graphics processing units or tensor processing units. The generative AI model performs tokenization of the prompt sentence, applies the trained neural network layers to compute probability distributions over output tokens, and generates a response sequence by sampling or greedy decoding according to parameters such as temperature or top-k thresholds.

The server receives the output of the generative AI model as a text sequence. Because the server instructed the model to output in a structured format, the server processes the sequence using a parser that validates the output against expected keys such as “stress_score”, “emotional_state_summary”, and “advice”. The server then converts the stress_score field to numerical information, for example a floating-point number between 0 and 10. This numericalization enables the server to perform precise, machine-scale computation over psychological state information across time. The server stores the numerical information together with the corresponding dream content and analysis result in the database, thereby augmenting history information for subsequent accesses.

The server further processes the advice information generated by the generative AI model. The server may maintain a set of rule-based templates or a secondary classification model that determines how to adjust the wording, length, or ordering of advice items. For example, the server may select shorter suggestions for a user who has indicated a preference for concise messages, or mark certain advice as high priority if the stress_score exceeds a threshold. The server thereby generates customized advice information for the user. The server also takes into account evaluation information or feedback information obtained from the user in past sessions. If the user has previously rated breathing exercises as unhelpful and walking as helpful, the server can reduce the frequency of breathing-related advice and emphasize walking or similar physical activities in subsequent customized advice information.

The server transmits the customized advice information to the terminal as structured data. The terminal receives this data and renders display information on the display unit. The terminal may show the numerical stress score, for example “Stress level: 8/10”, together with the emotional_state_summary and a bullet list of recommended actions. The user reads the presented advice, may follow the suggestions, and can optionally input evaluation or feedback information using interface components provided by the terminal.

The terminal collects evaluation information such as a rating or a binary indicator and free-form feedback text. The terminal transmits this information to the server. The server stores the evaluation and feedback information in the database with references to the corresponding dream record and analysis result. The server incorporates this information into subsequent prompt generation and advice customization. For example, the server introduces a parameter that weights past feedback when selecting or rephrasing advice items, and this parameter affects how history summary information is expressed in future prompt sentences.

The server implements access control and encryption processing for all stored data. The server assigns roles and permissions within the application such that only authorized processes can access sensitive fields. The server may use symmetric or asymmetric encryption for data at rest and for tokens or keys. The server may also pseudonymize stored user identifiers, replacing direct identifiers with pseudonymous keys. These measures reduce the risk of unauthorized disclosure while allowing the server to accumulate and process history information to improve analysis accuracy.

The described configuration improves computer technology beyond mere automation of human mental health counseling. First, the server restructures unstructured user text into a model-optimized prompt sentence that encodes historical numerical context and expected output schema. This restructuring reduces ambiguity in model input, stabilizes the distribution of outputs, and lowers the need for post-processing corrections, thereby improving computational efficiency and reducing network traffic caused by repeated retries. Second, by numericalizing psychological state information and storing it in a normalized database schema, the server enables efficient longitudinal computation using set-based operations, which are substantially faster and more scalable than repeatedly analyzing raw text. Third, by integrating user feedback into the prompt generation pipeline, the server implements an adaptive control loop over the interaction with the generative AI model, resulting in reduced error rates and improved personalization without requiring model retraining.

In another embodiment, the server uses a locally hosted generative AI model instead of a remote model. In this case, the server includes a model execution module configured to load trained neural network parameters into memory and perform inference using a matrix computation library optimized for vector instructions or hardware acceleration. The server may quantize model weights to reduce memory usage and increase throughput. The server can thereby reduce latency and communication load compared to calling a remote service.

In yet another embodiment, the server uses an ensemble of generative AI models and discriminator models. The server may first call a generative AI model to produce a preliminary analysis, then call a smaller classifier model to verify whether the stress_score lies within a plausible range given the dream content and history information. If the classifier detects inconsistency, the server may regenerate or adjust the prompt sentence to clarify ambiguous content and call the generative AI model again. This non-conventional control flow leads to improved robustness and reduces the frequency of outlier results, which is a technical improvement in automated analysis pipelines.

The server can further employ specialized data structures to manage prompt sentences and associated parameters. For example, the server may maintain a prompt cache indexed by a hash of the dream content and summarized history. If multiple requests share the same or similar context, the server can reuse a previously constructed prompt sentence, thereby reducing repeated string assembly and lowering CPU usage. The server may also store tokenized forms of frequently used instructions, so that only the user-specific portions of prompt sentences need to be dynamically generated. These structural optimizations reduce processing time and improve throughput.

The described architecture defines a specific data flow and module composition: the terminal module for user interaction, the server interface module for request handling and authentication, the history management module for storing and retrieving records, the prompt generation module for constructing prompt sentences, the model interaction module for calling the generative AI model, the analysis parsing module for extracting and numericalizing results, the customization module for generating user-tailored advice, the feedback integration module for updating parameters based on user responses, and the security module for performing access control and encryption. By clearly separating these modules and defining the data structures exchanged between them, the system achieves improved maintainability, parallelizability, and fault isolation, which are considered technical benefits in computer system design.

The terminal and the server can be modified in various ways without departing from the spirit of the invention. For example, the terminal may implement additional local preprocessing, such as local language detection or client-side encryption of dream content prior to transmission. The server may implement different database technologies, such as a document-oriented database, while maintaining the association between dream content, numerical information, and advice information. The generative AI model may be replaced with any model capable of processing a prompt sentence and producing analysis result information in response, including models based on recurrent neural networks or hybrid architectures that combine symbolic reasoning with neural processing. In each variation, the core technical concept remains that the server generates a structured prompt sentence incorporating historical numerical context, numericalizes psychological state information returned from the generative AI model, and adaptively refines subsequent processing based on stored history and feedback, thereby improving the computer-implemented pipeline for mental-health-related analysis and advice generation.

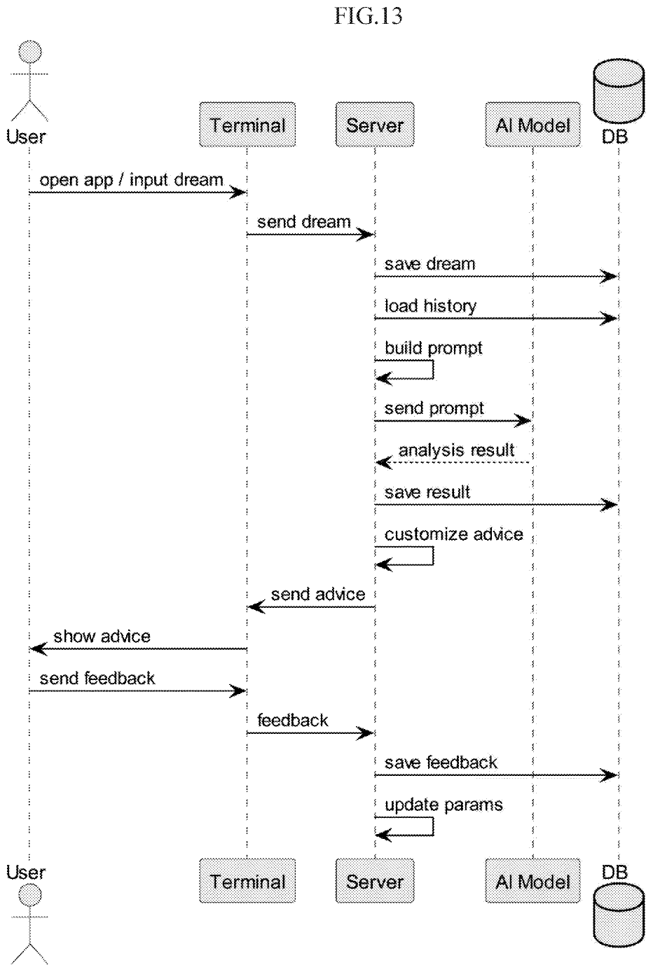

The following describes the processing flow using FIG. 13.

### Step 1:

The user operates the terminal to start an application and open a dream input screen.

The terminal displays an input form including a text field and a submit control.

Input: No prior program data; the terminal obtains user operations on the user interface.

Output: A blank dream input form presented to the user.

The terminal renders the form by loading layout definitions from local resources, allocating UI components in memory, and drawing them on the display so that the user can enter character-based dream content.

### Step 2:

The user inputs dream content into the text field on the terminal and activates the submit control.

The terminal acquires the entered characters, attaches metadata such as a local timestamp and a session token, and constructs a request payload.

Input: Keystrokes or touch events that represent the user's dream description.

Output: A structured request object containing dream content, timestamp, and authentication data.

The terminal serializes this request into a text-based format, sets HTTP headers including an authorization field, and transmits the request to the server over an encrypted communication channel.

### Step 3:

The server receives the request from the terminal via a network interface.

The server validates the authentication data, checks that the dream content field is present and not empty, and extracts a user identifier from the session token.

Input: The structured request object containing dream content, timestamp, and authentication data.

Output: A validated dream record in server memory associated with a specific user identifier.

The server performs parsing of the request payload, verifies token signatures, checks length constraints on the dream content, and discards or rejects invalid fields before passing the sanitized data to subsequent processing modules.

### Step 4:

The server stores the received dream content and associated metadata in a database.

The server creates a new record that includes at least a primary key, user identifier, dream text, creation time, and an initial placeholder for analysis results.

Input: The validated dream record in server memory.

Output: A persistent database entry identified by a dream record identifier.

The server executes a database insert operation using a prepared statement, receives the generated primary key, and caches this identifier in memory for use in later linkage with analysis results.

### Step 5:

The server retrieves history information for the same user from the database.

The server reads prior dream records, previously stored numerical indicators such as stress scores, and any stored feedback information.

Input: The user identifier and database connection parameters.

Output: A set of historical records including past dream texts, numerical scores, and timestamps.

The server executes a query filtered by the user identifier, sorts records by time, and loads the results into data structures such as arrays or lists in working memory.

### Step 6:

The server performs numerical and statistical processing on the retrieved history information.

The server computes values such as average stress score, maximum stress score, frequency of high-stress days, and other derived indicators.

Input: The set of historical records including past numerical scores and timestamps.

Output: Aggregated numerical indicators that summarize temporal changes in psychological state.

The server iterates over the historical records, accumulates scores, counts entries satisfying specified conditions, and divides by the number of samples to obtain averages or rates.

### Step 7:

The server generates a history summary text based on the aggregated numerical indicators and optionally on recurring dream themes.

The server may also analyze historical dream texts to detect frequently occurring motifs.

Input: Aggregated numerical indicators and optionally past dream texts.

Output: A history summary string describing typical stress levels and repeated patterns.

The server concatenates phrases that represent numerical ranges, inserts references to detected motifs, and composes a human-readable sentence such as “Over the last 3 weeks, the user's reported stress scores have ranged from 6 to 8, with frequent dreams of being chased and difficulty escaping.”

### Step 8:

The server constructs a prompt sentence for a generative AI model by combining the history summary text, the new dream content, and explicit instructions for output format.

The server loads a template and replaces placeholders with current data.

Input: The new dream text, the history summary string, and a prompt template.

Output: A complete prompt sentence string adapted to the generative AI model.

The server performs string substitution, escapes any problematic characters, appends task descriptions, and creates a final multi-line text that clearly defines the analysis target and required output fields.

### Step 9:

The server sends the constructed prompt sentence to the generative AI model through a model-serving interface.

The server packages the prompt sentence into a request formatted according to the model API specification.

Input: The complete prompt sentence string and configuration parameters such as model name and decoding settings.

Output: A model request transmitted to the generative AI model execution environment.

The server creates a message structure containing the prompt, sets parameters such as maximum response length and sampling strategy, serializes the structure, and transmits it over an encrypted network connection to the model endpoint.

### Step 10:

The generative AI model processes the prompt sentence and returns analysis result information to the server.

The server receives a text response from the model that follows the requested structure.

Input: The prompt sentence as seen by the generative AI model.

Output: A response string that contains psychological state information and advice information in a structured textual format.

The generative AI model internally tokenizes the prompt, applies neural network computations to infer stress level and generate advice, and outputs a text sequence that the server then captures via the model API.

### Step 11:

The server parses the response string from the generative AI model.

The server extracts fields corresponding to psychological state information, such as a stress score, an emotional state summary, and a list of advice items.

Input: The response string produced by the generative AI model.

Output: A set of structured data elements representing the analysis result information.

The server applies a parser to the output, validates the presence and types of expected fields, and converts the parsed elements into native data structures such as numbers, strings, and lists.

### Step 12:

The server converts at least part of the psychological state information into numerical information.

The server ensures that the stress score is represented as a numeric type suitable for arithmetic operations.

Input: The structured data elements containing psychological state information.

Output: Numerical values, such as a stress score, usable for statistical computation and comparison.

The server parses the stress score as a floating-point or integer value, checks that the value lies within an acceptable range, and stores it in variables dedicated to numerical processing.

### Step 13:

The server stores the analysis result information, including the numerical information, in association with the corresponding dream record.

The server updates the database entry created earlier to include the stress score, emotional summary, and advice content.

Input: The dream record identifier and the analysis result information including numerical values.

Output: An updated database record containing both raw dream content and associated analysis data.

The server executes an update operation that writes the new fields into the record, and commits the transaction so that future queries can use the enriched history.

### Step 14:

The server customizes the advice information based on user-specific conditions and stored history.

The server may adjust the selection, ordering, or phrasing of advice items according to factors such as recent trends in stress scores and past feedback.

Input: The advice information from the generative AI model, the numerical information, and user-specific history.

Output: Customized advice information tailored to the individual user.

The server applies rule sets or additional scoring functions to prioritize certain advice, removes items that conflict with user preferences, and optionally rephrases messages via additional text processing or a refinement call to the generative AI model.

### Step 15:

The server prepares an output payload that includes the current stress score, an emotional state summary, and the customized advice information.

The server formats this data according to the communication protocol used for responses to the terminal.

Input: Customized advice information, numerical stress score, and emotional summary text.

Output: A structured response object ready for transmission to the terminal.

The server constructs a response structure with clearly labeled fields, serializes it into a text-based representation, and attaches status codes and headers necessary for proper handling by the terminal.

### Step 16:

The server transmits the response payload containing the customized advice information to the terminal.

The terminal receives the payload and parses it into internal data structures appropriate for rendering.

Input: The structured response object sent by the server.

Output: Parsed content at the terminal side including a stress level indicator and a set of advice items.

The terminal reads the response body, checks status codes, deserializes the content, and maps the received fields to elements in the user interface.

### Step 17:

The terminal displays the analysis result and the customized advice information to the user.

The terminal renders elements such as a numeric stress gauge, descriptive text, and a list of recommended actions.

Input: Parsed content representing stress score, emotional summary, and advice list.

Output: Visual or other sensory output presented on the terminal display for the user.

The terminal calls its rendering subsystem to draw text and graphical elements and may also prepare interactive components such as buttons for feedback.

### Step 18:

The user reviews the displayed advice and optionally inputs evaluation information or feedback information on the terminal.

The terminal collects this input using interface elements such as rating buttons and text fields.

Input: The user's actions indicating usefulness or comments regarding the advice.

Output: A new feedback payload containing evaluation data linked to the corresponding dream record.

The terminal packages this feedback with identifiers referencing the analysis session and transmits it to the server in a separate request.

### Step 19:

The server receives the feedback payload from the terminal and links it to the relevant dream record and analysis result.

The server stores the feedback in a dedicated data structure or table for later use.

Input: The feedback payload containing evaluation information and references to specific advice.

Output: Stored feedback entries associated with user history records.

The server executes an insert or update operation in the database, associating the feedback with the dream record identifier and user identifier.

### Step 20:

The server updates internal parameters or selection rules used in prompt generation and advice customization based on accumulated feedback.

The server uses the feedback data to adjust weighting factors, thresholds, or rule conditions for future processing.

Input: Historical feedback entries related to past advice and analysis sessions.

Output: Modified internal configuration that influences subsequent prompt sentences and customized advice.

The server computes aggregates such as the proportion of “helpful” evaluations for each type of advice, updates stored parameters accordingly, and ensures that later processing steps consider these refined parameters to optimize technical performance and personalization.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented mental-health support systems generally rely on simple rule-based questionnaires or fixed decision trees that map a limited set of user answers to pre-authored advice. Such systems often process user input as shallow keyword matches or coarse sentiment labels, without performing rich natural language analysis, multi-dimensional feature extraction, or dynamic generation of context-aware guidance. As a result, these systems fail to accurately capture nuanced psychological states, such as stress patterns inferred from dream narratives, and are unable to provide tailored guidance that adapts over time to changes in a user's condition.

Furthermore, in many existing architectures, the computational pipeline from natural language input to mental-state estimation and advice generation is fragmented across separate components that are not tightly integrated. In particular, there is no coordinated mechanism in which a processor transforms free-form narrative text into structured analysis data, uses a deep learning model to infer stress indices, and then programmatically constructs optimized prompt sentences for a generative AI model. Consequently, the system cannot leverage the full expressive power of generative models in a controlled and repeatable way, and cannot efficiently reuse past analysis results to refine subsequent prompts or outputs.

In addition, conventional systems often store user data in an ad hoc manner that is not designed to support time-series analysis of mental states. Without systematic storage of text, intermediate analysis features, stress indices, and generated advice as coherent temporal records, the processor cannot compute trends, detect long-term deterioration or improvement, or automatically adapt the advice generation logic to those trends. This limits the ability of the underlying computer system to learn from historical interactions and to improve the relevance and precision of the outputs over time.

Privacy protection mechanisms in existing solutions are also frequently decoupled from the main processing pipeline. User identifiers, analysis data, and generated content may be stored without formal anonymization, encryption, or integrated access control. This creates technical constraints that either weaken privacy, or force conservative limitations on data processing, thereby reducing the richness of machine learning and statistical analysis that could otherwise improve system performance.

Accordingly, there is a need for an improved computer-implemented system and associated processing methods in which a processor: (i) guides a user to input narrative text describing dreams and related psychological states; (ii) performs multi-stage natural language processing to generate structured analysis data; (iii) executes a deep learning model to estimate stress indices and emotional states; (iv) dynamically constructs and updates prompt sentences to control a generative AI model for producing tailored advice; (v) stores all relevant artifacts as time-series records for each user; and (vi) enforces integrated anonymization and access control for privacy-preserving analysis. Such a system improves the functioning of the underlying computer technology by creating a closed-loop architecture that transforms raw text into adaptive, machine-generated guidance through coordinated use of natural language processing, deep learning, and generative modeling, while enabling longitudinal analysis under robust privacy constraints.

The specific processing by the specific processing unit 290 of the data processing device 12 in Application Example 2 is realized by the following means.

The present invention provides a server comprising a processor and a storage device, the processor being configured to cause an input/output apparatus to present display information that prompts a user to input character information regarding a psychological state including dream content, perform preprocessing on the character information received from the input/output apparatus by using a natural language processing algorithm that executes morphological analysis, phrase segmentation, important term extraction, and emotion estimation, and generate analysis data including emotion information and feature values, execute a stress estimation model that uses a deep learning algorithm with the analysis data as input to estimate a stress level and an emotional state of the user and to output a stress index, dynamically construct a prompt sentence for a generative AI model on the basis of the character information and the stress index included in an analysis result, input the prompt sentence into the generative AI model, cause the generative AI model to generate advice information in natural language including specific behavioral guidance for improving mental health, cause the input/output apparatus to present the advice information, store, for each user, the character information, the analysis data, the stress index, and the advice information as time-series data in a storage area of the storage device, execute statistical processing or machine learning processing on the time-series data to calculate a temporal change in a mental health state, change content of the prompt sentence or instruction conditions to the generative AI model in accordance with the calculated temporal change so as to individually optimize the advice information, convert user identification information included in the time-series data stored in the storage device into anonymized information, and apply an encryption process or an access control process to restrict access to the time-series data. This enables the computer system to implement an integrated, privacy-preserving processing pipeline that converts free-form psychological narrative text into structured analysis data, dynamically controls a generative AI model through optimized prompt sentences, and adaptively improves the quality and personalization of advice based on time-series analysis of stress and emotional states, thereby enhancing the overall performance and technical capabilities of the underlying information processing infrastructure.

The term “processor” refers to one or more hardware-based computation units, such as a central processing unit or an accelerator, configured to execute machine-readable instructions to perform the operations described herein.

The term “storage device” refers to one or more non-transitory computer-readable media, such as semiconductor memory or magnetic storage, configured to store programs, parameters, and data including character information, analysis data, stress indices, advice information, and time-series records.

The term “input/output apparatus” refers to one or more hardware-based user interface devices, such as a display unit, a keyboard, a pointing device, or a touch panel, that allow presentation of information to a user and reception of character information from the user.

The term “character information” refers to digital text data input by a user, the text data describing at least a psychological state including dream content, emotions, or thoughts, in a natural language.

The term “dream content” refers to narrative information describing events, scenes, or experiences remembered from a user's dream, represented in text form.

The term “psychological state” refers to a mental condition of a user, including but not limited to emotions, stress, anxiety, mood, or other internal experiences expressed through character information.

The term “display information” refers to digital presentation data, such as text or graphical user interface elements, output to an input/output apparatus in order to prompt or guide a user to input character information.

The term “natural language processing algorithm” refers to a software-implemented procedure executed by the processor that analyzes character information expressed in a natural language to derive linguistic or semantic structures, including but not limited to tokenization, parsing, or semantic interpretation.

The term “morphological analysis” refers to a processing operation that segments character information into tokens and determines grammatical features such as part-of-speech or base forms for individual tokens.

The term “phrase segmentation” refers to a processing operation that groups tokens or words into higher-level units, such as phrases or clauses, based on syntactic or statistical criteria.

The term “important term extraction” refers to a processing operation that identifies tokens, phrases, or expressions that are determined to be salient or relevant for subsequent analysis, such as keywords related to stressors, emotions, or recurring themes.

The term “emotion estimation” refers to a processing operation that assigns one or more emotion categories or scores to character information, based on statistical or machine learning models, to infer emotional characteristics such as fear, anxiety, joy, or sadness.

The term “analysis data” refers to structured digital information generated by the natural language processing algorithm from character information, including at least emotion information, feature values, and optionally tokens, phrases, or intermediate model outputs.

The term “emotion information” refers to data elements within the analysis data representing inferred emotional states, such as labels or numerical scores associated with one or more emotion categories.

The term “feature values” refers to numerical or categorical variables derived from character information or intermediate results, including but not limited to counts, embeddings, or scores that are suitable as input to a machine learning model.

The term “stress estimation model” refers to a machine-implemented inference mechanism, such as a trained neural network, that receives analysis data as input and outputs an estimated stress level or related index for a user.

The term “deep learning algorithm” refers to a category of machine learning techniques using multi-layer neural networks configured to learn representations and perform inference from input data, including but not limited to feed-forward networks, recurrent networks, or attention-based networks.

The term “stress level” refers to a quantitative or qualitative representation of a user's stress state, such as a scalar score, probability distribution, or categorical label describing the intensity of stress.

The term “emotional state” refers to an overall characterization of a user's emotions at a given time, inferred from character information and analysis data, and may include one or more emotion categories or composite indicators.

The term “stress index” refers to an output value of the stress estimation model that numerically or categorically indicates a degree or pattern of stress derived from the analysis data.

The term “analysis result” refers to a combined set of outputs produced by the natural language processing algorithm and the stress estimation model, including analysis data, emotion information, feature values, stress indices, and associated metadata.

The term “prompt sentence” refers to one or more text instructions constructed by the processor and provided as input to a generative AI model, the instructions specifying context, analysis results, and desired output behavior.

The term “generative AI model” refers to a machine learning model configured to generate natural language text or other content based on an input prompt, including but not limited to probabilistic language models and neural text generation models.

The term “advice information” refers to natural language output generated by the generative AI model, containing guidance, recommendations, or suggested actions for a user, including specific behavioral instructions related to mental health.

The term “behavioral guidance” refers to one or more concrete, executable actions suggested to a user, such as relaxation techniques, planning activities, or consultation actions, intended to influence mental or emotional well-being.

The term “information processing platform” refers to a combination of hardware and software components including at least a processor and a storage device, configured to execute the operations described for the system.

The term “time-series data” refers to data records associated with a particular user that are indexed by time, including character information, analysis data, stress indices, and advice information accumulated over multiple points in time.

The term “storage area” refers to a logically or physically defined region within the storage device used to store one or more items of time-series data.

The term “statistical processing” refers to computational operations that apply mathematical or statistical methods, such as averaging, variance analysis, trend detection, or correlation analysis, to time-series data.

The term “machine learning processing” refers to computational operations that apply one or more learning algorithms to time-series data in order to model, predict, or classify temporal patterns in mental health states.

The term “temporal change in a mental health state” refers to a variation, trend, or pattern over time in one or more indicators derived from time-series data, such as changes in stress indices or emotional states.

The term “instruction conditions to the generative AI model” refers to parameters or constraints provided together with a prompt sentence to control the generative AI model, including but not limited to style, length, focus, or safety restrictions.

The term “user identification information” refers to data capable of associating records with an individual user, such as identifiers or account-related attributes, before anonymization.

The term “anonymized information” refers to user-related data that has been transformed such that the identity of the user cannot be directly or reasonably inferred, for example by replacing identifiers or removing personally identifying attributes.

The term “encryption process” refers to a cryptographic operation that transforms readable data into an encoded form that is unintelligible without a corresponding decryption key.

The term “access control process” refers to a mechanism implemented in software or hardware that restricts or regulates read or write access to data based on authorization information, such as credentials, roles, or policies.

The term “privacy protection” refers to a state in which user-related data is processed and stored in a manner that reduces or prevents unauthorized identification, disclosure, or misuse of information relating to the user.

In one embodiment, a server cooperates with one or more terminals to implement the claimed system. The server includes at least one processor, a main memory, a non-transitory storage device, and a network interface. The terminal includes an input/output apparatus such as a display, a touch panel, and an audio output unit, and communicates with the server via a wired or wireless communication network.

The server stores, in the storage device, program modules including a natural language processing module, a feature-extraction module, a stress estimation module, a generative AI control module, a time-series analysis module, and a privacy management module. The processor executes these modules to perform the described data processing. The server may implement these modules using a general-purpose operating system and middleware. In one example, the natural language processing module and the stress estimation module are implemented in a high-level programming language runtime, while the generative AI control module communicates with an external generative AI model via an application programming interface.

The terminal presents, on the display of the input/output apparatus, a screen that prompts the user to input character information regarding a psychological state including dream content. The terminal displays an instruction such as:
“Please enter the content of your dream and how you felt. Example: Last night I dreamed that I was being chased through dark streets and I felt very scared.”

The user inputs dream content and related emotions via a keyboard, a touch panel, or voice-to-text input, and the terminal transmits the resulting character information to the server through a secured communication channel. The server receives the character information and stores a copy in the storage device together with a user identifier and a timestamp.

The server applies the natural language processing module to the received character information to transform unstructured text into structured analysis data. The natural language processing module uses a tokenization and morphological analysis component to segment the character information into tokens and assign part-of-speech tags and lemmas to each token. The module uses a phrase segmentation component to construct phrases and clauses from the tokens. The module uses an important term extraction component that computes term-frequency based scores, position-based weights, and attention-based relevance scores, to identify important terms associated with stressors, emotional events, or recurring dream themes. The module also uses an emotion estimation component that applies a trained classifier to embeddings of the tokens and phrases to assign emotion scores such as fear, anxiety, joy, and sadness.

The server represents the analysis data using a feature vector and associated metadata. The feature vector may include, for example, counts of important terms, averaged or pooled word embeddings, one-hot encoded emotion labels, and numerical emotion scores. The metadata may include a list of important terms, phrase boundaries, and a mapping from tokens to emotion contributions. By storing both the high-dimensional feature vector and the metadata, the server enables later re-use of intermediate computations for time-series analysis and prompt construction, thereby improving computational efficiency.

The server uses the stress estimation module to infer a stress index from the analysis data. The stress estimation module implements a deep learning algorithm. In one embodiment, the stress estimation module uses a multi-layer neural network that receives the feature vector as input and outputs a continuous stress score between 0 and 1. The neural network may include, for example, an input layer corresponding to the dimension of the feature vector, one or more hidden layers with non-linear activation units, and an output layer with a sigmoid activation that represents the stress probability. In another embodiment, the stress estimation module uses a recurrent or attention-based neural network that processes sequences of tokens or phrases to capture contextual patterns over the entire dream narrative.

The server trains the stress estimation module in advance using labeled training data that includes dream texts and reference stress labels assigned by qualified evaluators. The server uses a loss function such as cross-entropy loss or mean-squared error between predicted stress scores and reference labels. The server updates the neural network weights using gradient-based optimization such as stochastic gradient descent or a variant thereof. The server may apply regularization techniques such as dropout, weight decay, or early stopping, and may use data augmentation procedures such as synonym substitution or paraphrasing to increase the diversity of training samples. By designing the neural network and its training pipeline in this way, the server improves the accuracy and robustness of stress estimation, which in turn improves the quality of subsequent generative advice.

The server uses the generative AI control module to dynamically construct a prompt sentence for a generative AI model based on the character information and the stress index. The generative AI control module accesses the analysis data, including emotion information and important terms, and composes a multi-part prompt that informs the generative AI model of the context, the inferred emotional state, and the required output style and constraints. In one example, the server constructs a prompt sentence such as:
“You are a mental-health assistant. Analyze the following dream and emotional analysis, then provide short, practical, empathetic advice.
Dream: Last night I dreamed that I was being chased through dark streets and I felt very scared.
Analysis: dominant emotion=fear, stress level=high.
Task: suggest 3 concrete, simple actions the user can take today to reduce stress. Use supportive, non-judgmental language. Do not mention that you are an AI model.”

In another example, the server uses a different prompt template depending on the temporal trend of the user's mental state:
“The user has reported several dreams about failing an important exam over the past month.
Current dream: Last night I dreamed that I failed an important exam and everyone was disappointed in me.
Analysis: performance-related anxiety, stress level=medium-high.
As a mental-health assistant, generate 3 short, concrete actions the user can take this week to manage performance-related stress.”

The server passes the constructed prompt sentence as an input sequence to the generative AI model. The generative AI model may be an autoregressive language model or another form of generative neural network implemented on the same server or on an external processing resource accessed through the network interface. The generative AI model receives the prompt as tokenized text, conditions its internal hidden state on the prompt, and sequentially generates tokens representing advice information in natural language.

The server configures generation parameters such as maximum sequence length, temperature, and sampling strategy (for example, top-k or nucleus sampling) to balance diversity and safety of the outputs. The server may also use additional control tokens or system-level instructions within the prompt sentence to constrain the generative AI model to avoid certain topics or to maintain a particular tone. By exploiting the generative AI model in this controlled, prompt-driven manner, the server enables the computer system to synthesize advice that is highly contextualized, while avoiding random or unbounded generation that could reduce reliability.

The server receives the output sequence from the generative AI model and converts the tokens to text. The server splits the output text into discrete advice items, for example by detecting numbered lists or sentence boundaries, and formats the advice information for display on the terminal. The terminal presents the advice information to the user with clear visual organization, such as a list of actionable items and an indication of the estimated stress level. In one example, the terminal displays:
“Estimated stress level: High
1. Take a few minutes to practice slow, deep breathing when you wake up or before bed.
2. If you feel tense during the day, try a short walk in a safe, familiar place to help your body relax.
3. Consider writing down what is worrying you and breaking it into small, manageable tasks, so that your mind feels less overwhelmed.”

The server stores, for each user, the character information, the analysis data, the stress index, and the advice information as time-series data in the storage device. The server uses a structured data schema that associates each record with a user identifier (after anonymization), a timestamp, and references to the corresponding feature vector and neural network outputs. By organizing the data in this structured, time-indexed form, the server enables efficient retrieval of historical records and avoids repeated feature computations, thereby reducing processing time and resource consumption.

The server uses the time-series analysis module to process the stored data and derive temporal changes in mental health states. The time-series analysis module computes, for example, moving averages of stress indices, frequencies of particular emotion categories, and recurrence of specific important terms or dream themes. The module may also apply machine learning models such as temporal convolutional networks or recurrent networks that input sequences of stress indices and emotion vectors and output risk scores or trend indicators. Based on these computed temporal changes, the server adjusts the content of future prompt sentences or the instruction conditions to the generative AI model, such as:
“The user has experienced repeated fear-related dreams three times this week.
Current dream: Last night I was chased again, this time by an unknown person in a city.
Analysis: strong fear, increasing trend of stress.
Task: generate supportive advice that acknowledges the recurring theme and suggests practical steps, such as relaxation exercises, self-reflection, or seeking professional support.”

This feedback loop enables the system to adapt over time and to deliver advice information that reflects not only the current dream but also long-term patterns, thereby improving personalization and technical performance of the overall processing pipeline.

The server uses the privacy management module to convert user identification information into anonymized information before storing time-series data in the storage device. The module may apply hashing, tokenization, or pseudonymization techniques that prevent direct re-identification of users. The server applies encryption processes at the storage layer or the application layer to protect stored data, and enforces access control rules that restrict read and write operations to authorized processes. Because the privacy measures are integrated into the same processing pipeline that performs analysis and generation, the server can continue to perform complex machine learning and statistical operations on aggregated, anonymized data without exposing identifiable information, thereby improving both security and usability.

From a technical perspective, the server improves computer technology beyond a mere automation of human mental-health counseling. The server converts unstructured natural language text into structured, high-dimensional feature vectors and then executes specialized neural networks and time-series algorithms on those vectors. By reusing intermediate representations, by selectively recomputing only when new data deviates beyond thresholds, and by dynamically constructing prompts that tightly constrain generative outputs, the server reduces unnecessary computation and network traffic between the generative AI model and other components. This leads to improved throughput and reduced latency relative to naive architectures that would repeatedly send full raw text and receive unfiltered generative outputs.

The server improves accuracy and stability of results by using trained deep learning models for stress estimation and by using time-series analysis to detect gradual changes that would not be apparent from any single dream. The server improves data management by storing feature-level and model-output-level data in a structured time-series format, which permits efficient indexing, retrieval, and aggregation. The system therefore optimizes resource usage and enhances the determinism and reproducibility of advice generation, which are technical qualities of the computer system.

The server also executes processing that differs from conventional rule-based or human-driven evaluation. Instead of applying fixed decision trees, the server uses neural networks that learn complex relationships between linguistic features and stress levels. For example, the stress estimation model can assign different weights to combinations of important terms and emotion scores, and can capture non-linear interactions that are not easily encoded by hand-crafted rules. The generative AI control module then uses the numerical outputs of these models to form prompt sentences that encode constraints and context in a way that human operators would not typically generate at scale or with consistent structure. As a result, the computer system applies unique processing rules and data flows that are specifically tailored to machine execution and optimization, rather than mimicking human reasoning in a simplistic manner.

In another embodiment, the server executes the generative AI model locally on a specialized hardware accelerator, such as a graphics processing unit or a tensor processing unit. In this case, the server stores model parameters of the generative AI model and loads them into accelerator memory. The server then uses batched prompt sentences and batched inference to improve hardware utilization and to support multiple users concurrently. The server may implement caching strategies for partial hidden states corresponding to prompt prefixes that recur across similar dreams or user groups, thereby further reducing repeated computation and improving response time.

In yet another embodiment, the stress estimation model is implemented as an attention-based neural architecture that receives both token embeddings and positional encodings. The server uses a multi-head attention mechanism to focus on different parts of the dream narrative, such as threat-related phrases or failure-related expressions. The server aggregates attention-weighted token representations into a final stress representation vector, which is then passed through fully connected layers to produce the stress index. Compared to simple averaging of embeddings, this architecture allows the server to emphasize contextually important segments of the dream text, thereby enhancing prediction accuracy and reducing noise from irrelevant words.

In a further embodiment, the time-series analysis module uses anomaly detection algorithms to detect sudden spikes in stress indices or abrupt changes in dominant emotions. When such anomalies are detected, the server adjusts the prompt sentence to include explicit references to these changes and may modify the instruction conditions to the generative AI model to request more cautious or supportive advice. This adaptive behavior relies on technical processing of numerical time-series signals and on dynamic control of the generative model's behavior, leading to improved reliability and targeted intervention.

The terminal can be implemented as a mobile communication device, a tablet, or a desktop computing device. The terminal executes a client application that communicates with the server, displays prompts and advice information, and may also display visual graphs of stress indices and emotion trends over time. By rendering this information locally and by offloading heavy computation to the server, the terminal maintains responsiveness and reduces battery consumption, while the server centralizes and optimizes the intensive natural language and neural network processing.

Through these embodiments and their variations, the server, the terminal, and the user interact in a coordinated manner, and the computer-implemented system executes specific technical processing using a natural language processing algorithm, a deep learning stress estimation model, a generative AI model controlled by prompt sentences, and time-series data structures. This configuration yields concrete technical effects such as improved processing speed, higher accuracy of stress estimation, efficient storage and retrieval of analysis data, adaptive and constrained text generation, and integrated privacy protection, all of which collectively enhance the performance and capabilities of the underlying information processing infrastructure.

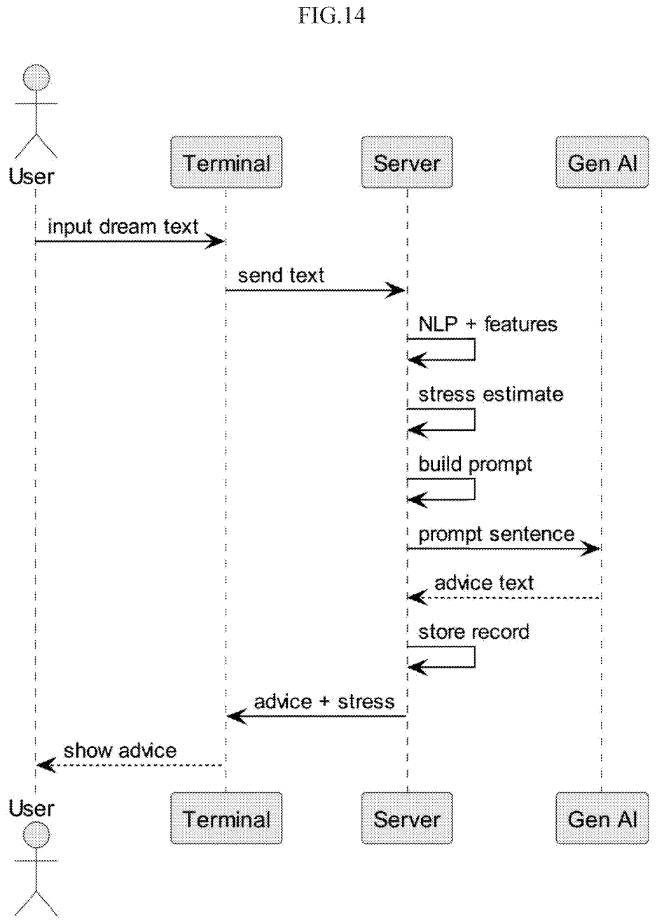

The following describes the processing flow using FIG. 14.

### Step 1:

User operates the terminal to input dream content and emotions.

User views a screen on the terminal that displays an instruction such as “Please enter the content of your dream and how you felt.” and then types text describing a dream and associated feelings into a text field. User may input, for example: “Last night I dreamed that I was being chased through dark streets and I felt very scared.”

Input: Natural-language character information representing the user's dream and emotions.

Output: Local text data held in the terminal's memory for transmission.

### Step 2:

Terminal transmits the input text to the server via a secure communication channel.

Terminal packages the local text data together with a user identifier and a timestamp into a message structure and sends the message to the server over an encrypted network connection. Terminal may add metadata such as device type or language settings.

Input: Local text data (dream content and emotions) and metadata.

Output: Network message containing the text data and metadata delivered to the server.

### Step 3:

Server receives and validates the incoming message.

Server reads the network message via a network interface, checks that required fields such as dream text and timestamp are present, validates authentication information, and normalizes the character encoding to a standard format. Server rejects malformed input and logs errors when necessary.

Input: Network message including dream text, user identifier, and timestamp.

Output: Validated and normalized character information stored in working memory, plus a record of validation status.

### Step 4:

Server performs text preprocessing using a natural language processing algorithm.

Server applies tokenization to split the character information into tokens, executes morphological analysis to determine part-of-speech tags and base forms, and performs phrase segmentation to group tokens into phrases and clauses. Server also removes stop words and punctuation and converts text to a normalized case.

Input: Validated and normalized character information.

Output: Structured linguistic representation including tokens, lemmas, part-of-speech tags, and phrase boundaries.

### Step 5:

Server executes important term extraction and emotion estimation.

Server calculates term-importance scores using frequency-based measures, positional weights, and optionally attention-based relevance scores, and selects tokens or phrases with scores above a threshold as important terms. Server then computes vector embeddings for tokens and phrases and applies a trained emotion classifier to estimate probabilities for emotion classes such as fear, anxiety, joy, and sadness.

Input: Structured linguistic representation from Step 4.

Output: Analysis data including a list of important terms, emotion labels, and numerical emotion scores.

### Step 6:

Server constructs a feature vector for stress estimation.

Server converts the analysis data into numerical and categorical feature values by encoding counts of important terms, aggregating embeddings into a fixed-length vector, and appending emotion scores and other contextual indicators such as dream length or recent frequency of similar terms. Server arranges these values into a single feature vector with a defined dimension.

Input: Analysis data including important terms and emotion scores.

Output: Fixed-dimension feature vector representing the dream and emotional content.

### Step 7:

Server estimates a stress index using a deep learning stress estimation model.

Server feeds the feature vector into a trained neural network that contains an input layer, one or more hidden layers with non-linear activation functions, and an output layer that produces a continuous stress score between 0 and 1. Server performs the necessary matrix multiplications and activation computations, and optionally applies a threshold or mapping to convert the score into categorical levels such as low, medium, or high.

Input: Feature vector from Step 6.

Output: Stress index value and, optionally, a stress level label representing the estimated stress of the user.

### Step 8:

Server composes an analysis summary for use in prompt construction.

Server combines the original character information, the list of important terms, the emotion scores, and the stress index into a structured summary object. Server may also include short textual phrases describing the dominant emotion and stress level, such as “dominant emotion=fear, stress level=high.”

Input: Original character information, analysis data, and stress index.

Output: Analysis summary object containing text, extracted features, and interpreted stress information.

### Step 9:

Server dynamically constructs a prompt sentence for a generative AI model.

Server selects an appropriate template based on the analysis summary and the user's historical trend, then inserts the current dream text, the dominant emotion, and the stress level into the template. Server also appends explicit instructions regarding the required output style and number of advice items. For example, server generates a prompt such as:
“You are a mental-health assistant. Analyze the following dream and emotional analysis, then provide short, practical, empathetic advice. Dream: Last night I dreamed that I was being chased through dark streets and I felt very scared. Analysis: dominant emotion=fear, stress level=high. Task: suggest 3 concrete, simple actions the user can take today to reduce stress. Use supportive, non-judgmental language. Do not mention that you are an AI model.”

Input: Analysis summary object from Step 8 and prompt templates.

Output: Prompt sentence text to be supplied to the generative AI model.

### Step 10:

Server invokes the generative AI model with the constructed prompt sentence.

Server converts the prompt sentence into token IDs using a tokenizer associated with the generative AI model and sends the token sequence to the model. Server specifies generation parameters such as maximum length, temperature, and sampling strategy, and then executes forward passes through the model's network layers to obtain probability distributions over next tokens until an end condition is met.

Input: Prompt sentence text and generation parameters.

Output: Generated token sequence representing advice information in natural language.

### Step 11:

Server post-processes the generated advice information.

Server converts the generated token sequence back into text and examines the output to remove leading or trailing artifacts and to identify individual advice items, for example by detecting line breaks or numbering. Server checks the text for prohibited content based on predefined rules and may truncate or reformat the text if limits on length or number of items are exceeded.

Input: Generated token sequence from Step 10.

Output: Cleaned and structured advice information text, possibly segmented into multiple advice items.

### Step 12:

Server stores time-series data for the user.

Server assembles a record that includes the original dream text, the analysis data, the feature vector, the stress index, and the generated advice, together with a timestamp and an anonymized user identifier. Server writes this record into a storage area of the storage device using a schema that indexes entries by anonymized identifier and time, enabling efficient retrieval and aggregation.

Input: Original character information, analysis data, stress index, and advice information.

Output: Persisted time-series record in the storage device associated with the user.

### Step 13:

Server performs time-series analysis to derive temporal changes.

Server retrieves multiple past records for the same anonymized user and extracts sequences of stress indices, emotion scores, or counts of important terms. Server applies statistical operations such as moving averages and trend estimation, or executes temporal machine learning models to detect increasing stress or recurrent emotional themes.

Input: Time-series records for a user from the storage device.

Output: Temporal change indicators, such as trend values or anomaly flags, representing changes in the user's mental health state.

### Step 14:

Server adjusts future prompt construction based on temporal changes.

Server uses the temporal change indicators to modify future prompt templates or instruction conditions, for example by adding references to repeated dream themes or by requesting more detailed coping strategies from the generative AI model. Server updates configuration parameters that control how new prompt sentences will be built for subsequent dreams of the same user.

Input: Temporal change indicators from Step 13.

Output: Updated prompt construction rules and parameters stored for use in subsequent processing.

### Step 15:

Server transmits the advice information and related summary to the terminal.

Server creates a response message that includes the cleaned advice items, the stress level label or value, and optionally a brief textual summary of the analysis. Server sends this response to the terminal over the secure network connection.

Input: Structured advice information and stress index from previous steps.

Output: Network response message containing advice and stress information delivered to the terminal.

### Step 16:

Terminal displays the advice and optional summary to the user.

Terminal receives the response message, parses the stress information and advice items, and renders them on the display. Terminal may show, for example, “Estimated stress level: High” followed by a numbered list of concrete actions. Terminal organizes the content visually and may provide interface elements for the user to indicate understanding or satisfaction.

Input: Network response message from the server.

Output: Visual presentation of stress information and advice on the terminal's display for the user to view.

### Step 17:

User reviews the presented advice and optionally provides feedback.

User reads the displayed advice on the terminal and may choose to follow one or more suggested actions. User may also input feedback such as “This advice was helpful” via buttons or text input.

Input: Visual presentation of advice and, optionally, user feedback controls.

Output: User behavioral decision (following advice) and, optionally, feedback data entered into the terminal.

### Step 18:

Terminal sends optional user feedback to the server.

Terminal captures any feedback provided by the user and packages it with the corresponding record identifier into a message. Terminal transmits this message to the server using the same secure communication channel.

Input: User feedback data and associated identifiers.

Output: Feedback message delivered to the server for use in future analysis or model refinement.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

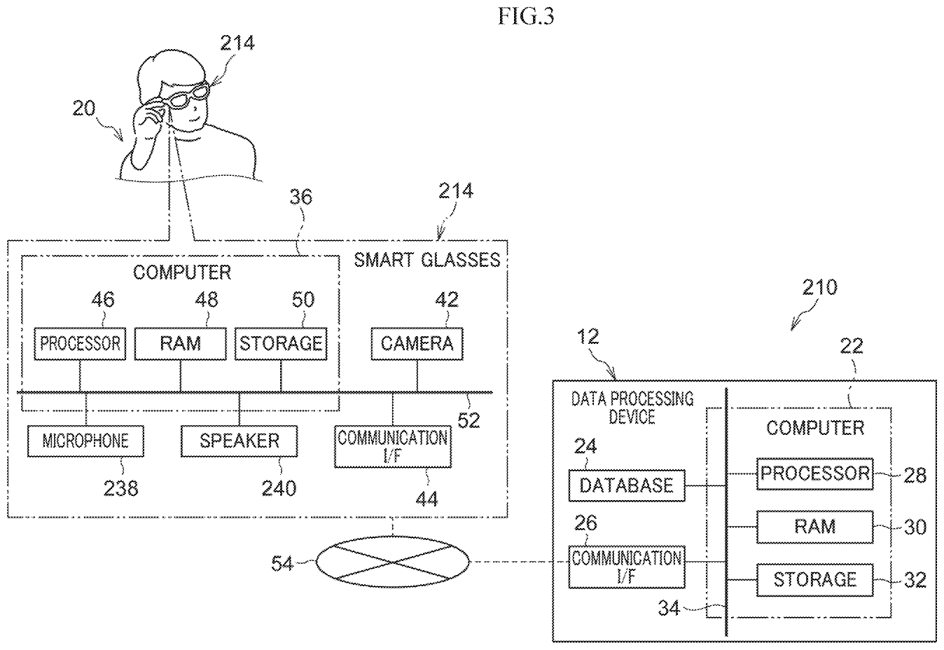

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

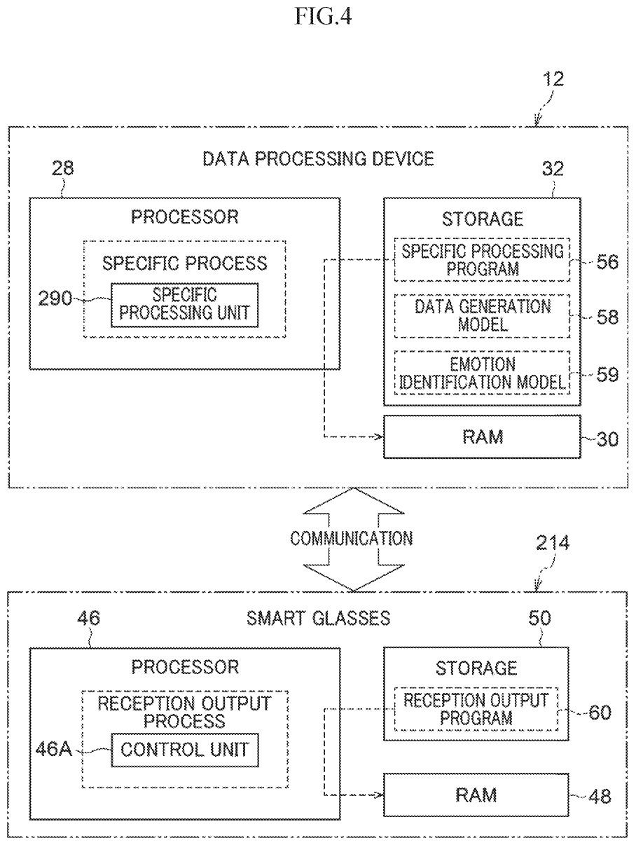

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

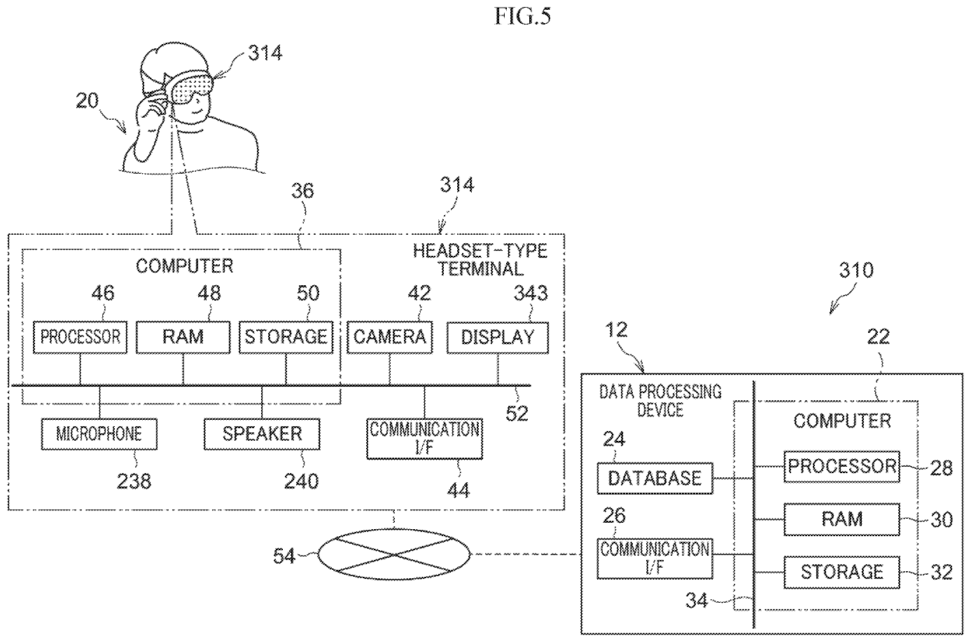

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

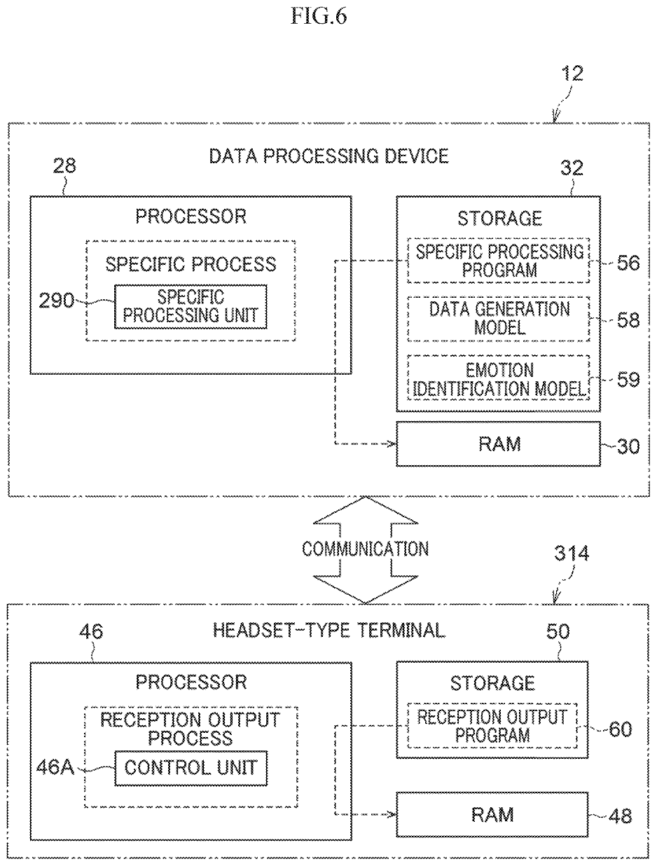

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

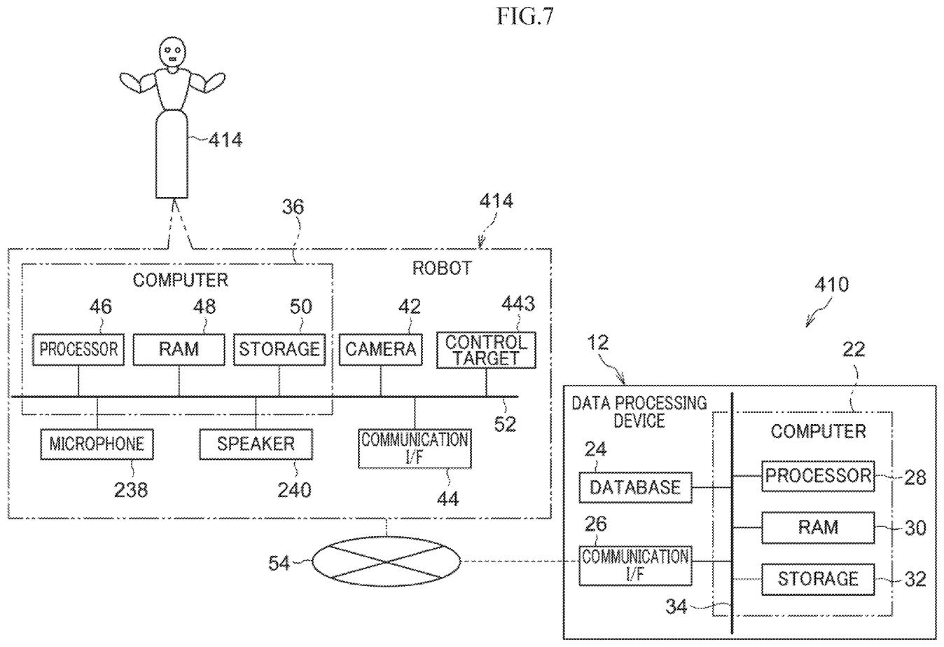

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

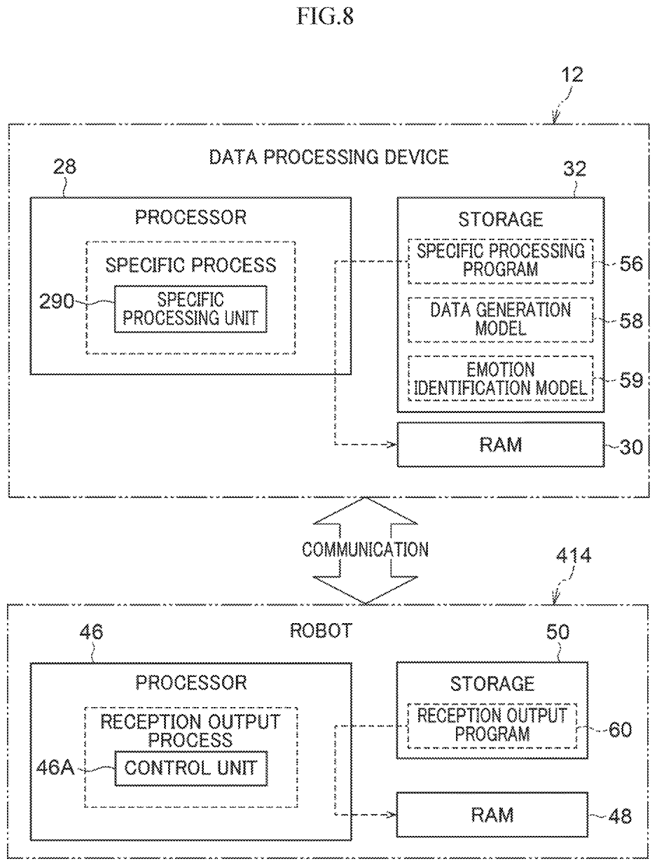

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

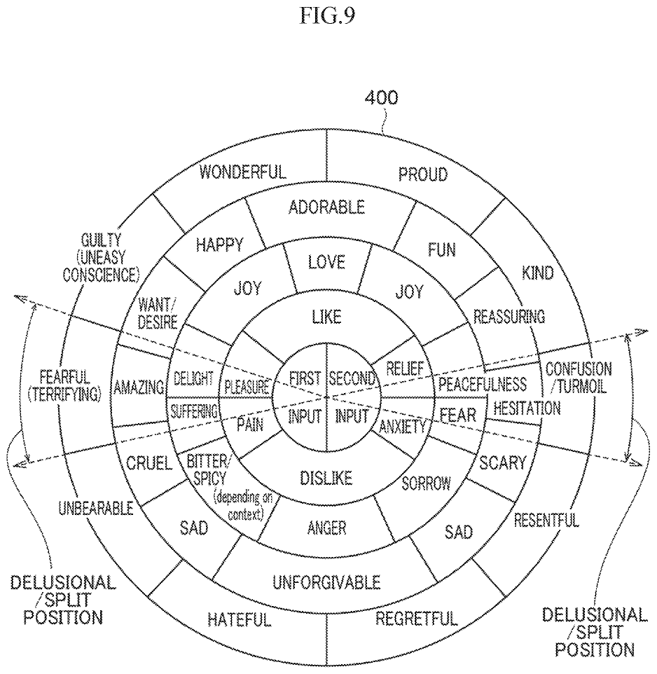

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o′clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

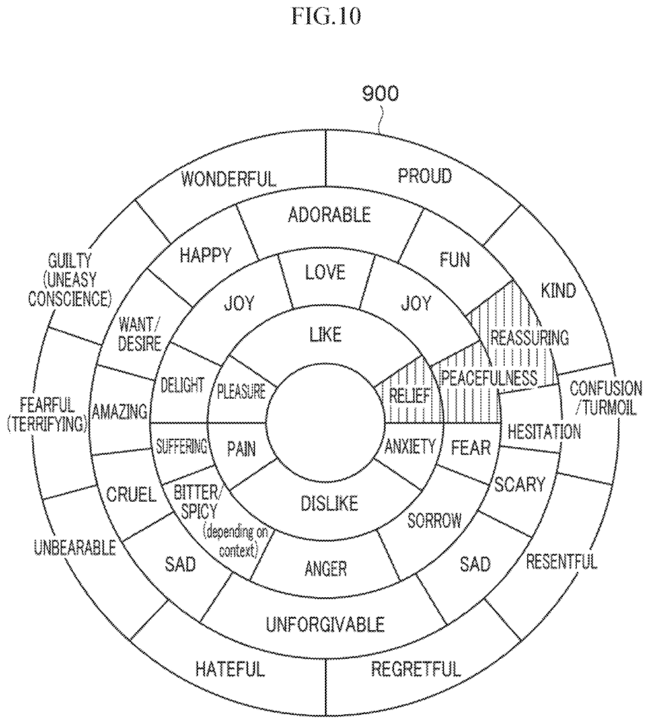

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
present, on an information terminal, an interactive screen that allows a user to input
description information representing dream content experienced during sleep,
receive, from the information terminal via a secure communication scheme, the description information, generate a prompt sentence that includes the description information for analysis, and generate analysis input data including the prompt sentence,
execute, on an information processing apparatus, a generative AI model having natural language processing functionality and deep learning functionality so as to subdivide the analysis input data into symbol sequences, convert the symbol sequences into numerical representations, extract feature quantities, and generate state information indicating a psychological state of the user and explanation information indicating a basis for the state information,
generate advice information intended to improve mental health of the user based on the state information,
transmit the advice information and the state information to the information terminal as response information so that the advice information and the state information are displayed on the interactive screen, and
record, in a storage device as a data collection, the description information, the state information, and the advice information in a form separated from identification information.

### (Supplementary 2)

The system according to supplementary 1,
wherein the processor is configured to
acquire, from the data collection in the storage device, a plurality of pieces of state information corresponding to the same anonymous user, calculate trend information regarding temporal changes based on the acquired state information, generate summary information including the trend information by using a prompt sentence for the generative AI model, and update the advice information based on the summary information and provide the updated advice information to the information terminal.

### (Supplementary 3)

The system according to supplementary 1,
wherein the processor is configured to
before associating the description information and the state information with user identification information, convert the user identification information into anonymous information by performing irreversible transformation processing and attribute generalization processing, associate the anonymous information with the description information and the state information and record the anonymous information, and restrict an access range to the recorded information for external references based on authentication information and access control information.

### Application Example 1

### (Supplementary 1)

A system comprising a processor,
wherein the processor is configured to
provide, by an information processing device, a user interface including a display area and a character input area on an information input/output device so that a user can input dream contents as character information,
acquire, by the information processing device, the character information, perform preprocessing including character string normalization and division of the character information into morpheme units or symbol units, and convert a result of the division into a numerical sequence,
execute, by the information processing device, a deep learning model including a multilayer neural network using the numerical sequence, and generate an analysis result of the dream contents by calculating numerical information representing an emotional state and a stress index,
perform, by the information processing device, threshold determination or rule-based determination on the analysis result, and identify a mental health state including a dominant emotion, a stress level, and a classification category of the dream contents,
construct, by the information processing device, a prompt sentence including an instruction statement based on the dream contents and the mental health state, input the prompt sentence to a generative information processing model provided inside or outside the system, and
cause the generative information processing model to generate an advice sentence in a natural language,
present, by the information processing device, the generated advice sentence to the user via the user interface, and
perform, by the information processing device, anonymization processing on the dream contents, the analysis result, and the advice sentence by removing or replacing personal identification information, and store the anonymized information in a storage device.

### (Supplementary 2)

The system according to supplementary 1,
wherein the processor is configured to
use, by the information processing device, anonymized dream contents and corresponding analysis results stored in the storage device over a predetermined period in statistical processing or learning processing to update parameters of the deep learning model or conditions for constructing the prompt sentence, and generate, based on the updated deep learning model or the updated conditions for constructing the prompt sentence, an optimized advice sentence corresponding to a mental health state of each user.

### (Supplementary 3)

The system according to supplementary 1,
wherein the processor is configured to
extract, by the information processing device, character strings indicating name information, geographic information, and contact information by character string pattern determination or natural language processing-based identification information detection in the anonymization processing, automatically replace the extracted character strings with generalized substitute symbols, and perform access control processing that controls access rights to information stored in the storage device according to a user attribute or a processing purpose.

### Example 2

### (Supplementary 1)

A system comprising a processor,
wherein the processor is configured to
cause a terminal to provide an interface through which a user inputs dream content as character-based information and to acquire the dream content from the terminal,
generate a prompt sentence, based on the dream content received from the terminal and history information associated with the dream content, the prompt sentence defining the dream content as an analysis target for a generative AI model,
input the prompt sentence into the generative AI model and obtain analysis result information including psychological state information related to the dream content and advice information based on the psychological state information, the analysis result information being generated by natural language processing performed by the generative AI model,
express the psychological state information included in the analysis result information as numerical information and store the numerical information in a storage device in association with the dream content and the history information,
generate customized advice information by selecting the advice information based on the numerical information and the history information and by adjusting at least one of wording, expression format, and presentation content of the advice information in accordance with an individual situation of the user,
transmit the customized advice information to the terminal and enable the terminal to output the customized advice information as display information in a form presentable to the user, and
protect privacy of the user by performing access control and encryption processing on stored information including the dream content, the analysis result information, the numerical information, and the customized advice information.

### (Supplementary 2)

The system according to supplementary 1,
wherein the processor is configured to
calculate, based on numerical information and dream content stored in the storage device for a plurality of time points, a change in psychological state over time in a statistical manner,
generate history summary information summarizing the change, and input a prompt sentence including the history summary information into the generative AI model so as to improve accuracy of the analysis result information and the customized advice information.

### (Supplementary 3)

The system according to supplementary 1,
wherein the processor is configured to
acquire evaluation information or feedback information from the terminal regarding the customized advice information, store the evaluation information or the feedback information in the storage device, and take the evaluation information or the feedback information into account in generation processing of the prompt sentence and in generation processing of the customized advice information so as to adaptively optimize advice information to be provided thereafter.

### Application Example 2

### (Supplementary 1)

A system comprising a processor,
wherein the processor is configured to
cause an input/output apparatus to present display information that prompts a user to input character information regarding a psychological state including dream content,
perform preprocessing on the character information received from the input/output apparatus by using a natural language processing algorithm that executes morphological analysis, phrase segmentation, important term extraction, and emotion estimation, and generate analysis data including emotion information and feature values,
execute a stress estimation model that uses a deep learning algorithm with the analysis data as input to estimate a stress level and an emotional state of the user and to output a stress index, dynamically construct a prompt sentence for a generative AI model on the basis of the character information and the stress index included in an analysis result, input the prompt sentence into the generative AI model, cause the generative AI model to generate advice information in natural language including specific behavioral guidance for improving mental health, and cause the input/output apparatus to present the advice information, and cooperatively control the foregoing operations on an information processing platform including the processor and a storage device.

### (Supplementary 2)

The system according to supplementary 1,
wherein the processor is configured to
store, for each user, the character information, the analysis data, the stress index, and the advice information as time-series data in a storage area of the storage device, execute statistical processing or machine learning processing on the time-series data to calculate a temporal change in a mental health state, and change content of the prompt sentence or instruction conditions to the generative AI model in accordance with the calculated temporal change so as to individually optimize the advice information.

### (Supplementary 3)

The system according to supplementary 1,
wherein the processor is configured to
convert user identification information included in the time-series data stored in the storage device into anonymized information, apply an encryption process or an access control process to restrict access to the time-series data, and perform processing by the natural language processing algorithm, the stress estimation model, and the generative AI model while maintaining privacy protection.

What is claimed is:

1. A system comprising:
circuitry configured to:
receive, via a communication interface coupled to a packet-switched network, description information representing input content provided by a user via a terminal device, and generate a prompt sentence comprising the description information as analysis input data;
execute a generative model having natural language processing functionality and deep learning functionality on the analysis input data to subdivide the analysis input data into symbol sequences, convert the symbol sequences into numerical representations, and extract feature quantities;
generate state information comprising a state classification of the user and explanation information indicating a basis for the state information based on the extracted feature quantities; and
generate advice information based on the state information, and transmit the advice information and the state information to the terminal device via the communication interface as response information.

2. The system according to claim 1, wherein the circuitry is configured to
record the description information and corresponding state information in a storage device as time-series data indexed by user identifier and timestamp, and calculate a temporal change in the state classification based on the accumulated time-series data.

3. The system according to claim 2, wherein the circuitry is configured to
change content of the prompt sentence or instruction conditions to the generative model in accordance with the calculated temporal change to individually optimize the advice information based on the observed trend in the state classification.

4. The system according to claim 3, wherein the circuitry is configured to
apply a trend analysis model to the time-series data to identify directional patterns and inflection points in the state classification, and incorporate the identified patterns as conditioning parameters in the prompt sentence for advice generation.

5. The system according to claim 4, wherein the circuitry is configured to
generate a long-term state summary from the time-series data at predetermined intervals, and transmit the long-term state summary to the terminal device via the communication interface.

6. The system according to claim 1, wherein the circuitry is configured to
apply an anonymization function to user identification information included in the time-series data stored in the storage device, and apply an encryption process or an access control process to restrict access to the time-series data while maintaining processing capability for the natural language processing algorithm and the generative model.

7. The system according to claim 6, wherein the circuitry is configured to apply a differential privacy mechanism to statistical outputs derived from the time-series data to prevent identification of individual users from aggregate analysis results.

8. The system according to claim 1, wherein the circuitry is configured to
apply a transformer-based deep learning model to the numerical representations to generate contextual embedding vectors, apply a classification model to the contextual embedding vectors to generate the state information comprising a psychological state category and a confidence score.

9. The system according to claim 8, wherein the circuitry is configured to
apply a multi-label classification model to the contextual embedding vectors to assign multiple psychological state categories simultaneously, and incorporate all assigned categories with their confidence scores in the state information.

10. The system according to claim 1, wherein the circuitry is configured to
apply a semantic segmentation model to the description information to identify thematic segments, apply a sentiment analysis model to each thematic segment to generate per-segment sentiment scores, and aggregate the per-segment scores to generate a composite state representation.

11. The system according to claim 10, wherein the circuitry is configured to
apply a keyword extraction model to each thematic segment to identify recurring symbols and motifs, and incorporate the identified symbols and motifs as structured parameters in the prompt sentence for state information generation.

12. The system according to claim 1, wherein the circuitry is configured to
generate the advice information by applying the generative model to a prompt sentence that incorporates the state information, the explanation information, and a target improvement objective, and format the advice information as a structured recommendation comprising short-term and long-term components.

13. The system according to claim 12, wherein the circuitry is configured to
receive feedback information from the terminal device indicating user response to the advice information, and update the prompt sentence generation parameters based on the feedback information to improve alignment between advice information and user needs.

14. The system according to claim 1, wherein the circuitry is configured to
apply a stress estimation model to the description information using physiological indicator data received from the terminal device, and incorporate a stress index derived from the stress estimation model as an additional input to the state information generation.

15. The system according to claim 14, wherein the circuitry is configured to
receive physiological indicator data comprising heart rate variability data and skin conductance data from a wearable device connected to the terminal device, and apply the stress estimation model to the physiological indicator data to generate the stress index.

16. The system according to claim 1, wherein the circuitry is configured to
receive the description information via a secure communication scheme comprising end-to-end encryption, and apply a protocol validation function to verify the integrity of the received description information prior to generating the analysis input data.

17. The system according to claim 16, wherein the circuitry is configured to
apply a data completeness verification model to the description information to identify missing or ambiguous content segments, and generate a clarification request for transmission to the terminal device when incomplete segments are detected.

18. A system comprising:
circuitry configured to:
receive, via a communication interface coupled to a packet-switched network, description information from a terminal device, generate a prompt sentence comprising the description information, and execute a generative model to subdivide the analysis input data into symbol sequences, convert the symbol sequences into numerical representations, and extract feature quantities;
apply a transformer-based deep learning model to the numerical representations to generate contextual embedding vectors, apply a multi-label classification model to generate state categories and confidence scores, and generate state information and explanation information;
generate advice information by applying the generative model to a prompt sentence incorporating the state information, a target improvement objective, and temporal change data derived from time-series data stored in a storage device;
apply an anonymization function and access control process to user identification information in the time-series data while maintaining processing capability, and apply a differential privacy mechanism to statistical outputs; and
transmit the advice information, the state information, and the explanation information to the terminal device via the communication interface.

19. The system according to claim 18, wherein the circuitry is configured to
receive physiological indicator data from a wearable device connected to the terminal device, apply a stress estimation model to generate a stress index, incorporate the stress index in the state information generation, and record updated time-series data comprising the description information and corresponding state information and stress index in the storage device.

20. A method comprising:
receiving, via a communication interface coupled to a packet-switched network, description information representing input content provided by a user via a terminal device, and generating a prompt sentence comprising the description information as analysis input data;
executing a generative model having natural language processing functionality and deep learning functionality on the analysis input data to subdivide the analysis input data into symbol sequences, convert the symbol sequences into numerical representations, and extract feature quantities;
generating state information comprising a state classification of the user and explanation information indicating a basis for the state information based on the extracted feature quantities; and
generating advice information based on the state information, and transmitting the advice information and the state information to the terminal device via the communication interface as response information.
